(19) United States
(12) Patent Application Publication
(10) Pub. No.: US 2008/0227016 A1
(43) Pub. Date: Sep. 18, 2008

(54) LATENT ELECTROSTATIC IMAGE DEVELOPING TONER, IMAGE FORMING APPARATUS AND IMAGE FORMING METHOD

(76) Inventors: Tsuyoshi NOZAKI, Osaka (JP); Chiyoshi Nozaki, Otsu-shi (JP); Atsushi Yamamoto, Kawanishi-shi (JP); Mitsuyo Matsumoto, Osaka (JP); Takuya Kadota, Kobe-shi (JP); Hiroyuki Murakami, Osaka (JP); Katsunori Kurose, Takarazuka-shi (JP); Yoshimichi Ishikawa, Itami-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/046,869

(22) Filed: Mar. 12, 2008

(30) Foreign Application Priority Data
Mar. 16, 2007 (JP) 2007-067904
Mar. 19, 2007 (JP) 2007-069719

(51) Int. Cl. G03G 9/087; G03G 13/20; G03G 15/20

(52) U.S. Cl. 430/109.4; 430/124.1; 399/320

(57) ABSTRACT

A latent electrostatic image developing toner of the present invention is mainly composed of two or more binder resins, a colorant, a releasing agent and a layered compound. A first binder resin of the binder resins is a polyester resin with an acid value of 15 KOHmg/g or less. The layered compound is a compound in which at least some interlayer ions are modified by organic ions. Toner particles are prepared by granulation in an aqueous medium, and the layered compounds are localized in the surface of the particles by the pelletization in the granulation. The average circularity of the particles is 0.970 or more.

### BACKGROUND OF THE INVENTION

1. Field of the Invention

The present invention relates to a latent electrostatic image developing toner. More particularly, the present invention relates to a latent electrostatic image developing toner enabled to be used for a compact cleanerless image forming apparatus, which takes up less space, and to form a stable high-quality image with less toner waste. The present invention also relates to a developer, a toner container, an image forming apparatus and a process cartridge, which employ the toner.

2. Description of the Related Art

Conventional contact fusing fixing method using a heat roller and the like has been employed widely to fix a toner. A fixing device used for the contact fusing fixing method is provided with a heat roller and a pressure roller. When a recording sheet, which bears a toner image, passes through a pressure contact portion (nip) between the heat roller and the pressure roller, the fixing device fuses and fixes the toner image onto the recording sheet.

In the contact fusing fixing method (e.g., using a heat roller and the like), the surface of a heat member (e.g., a heat roller), which is provided in a contact fusing fixing device, contacts and fixes a toner image on a recording sheet. However, part of the toner image adheres to the heat member and is transferred to a next recording sheet, thereby smearing the sheet (i.e., “toner offset”). Thus, it is necessary to prevent the toner offset.

To prevent the toner offset, it is known to apply fixing oil such as a silicone oil to the heat roller and the pressure roller of the fixing device or impregnate these rollers with the oil. An oilless fixing device without a fixing oil applying unit or a fixing device applying less fixing oil has been employed to reduce the size and manufacturing costs of the fixing device. When one of these fixing devices is employed, a releasing agent is added to toner as an offset-preventing agent.

In addition, a heating temperature is preferably as low as possible in the fusing fixing method to save energy. However, when the thermal properties of a binder resin, which constitutes the toner, are designed to be extremely low, thermal resistance and storage stability of the toner deteriorate, thereby causing blocking or the like. To achieve a low fixing temperature and the thermal resistance and storage stability, it is advantageous to use polyester resins as the binder resin. The polyester resins have excellent low-temperature fixability and favorable thermal resistance and storage stability because the polyester resins are less viscous and more elastic than a vinyl copolymer resins.

Recently, polymerization and other methods (e.g., for a new type of a toner such as chemical toner) have been used to manufacture a toner instead of conventional pulverization. Among these methods, suspension polymerization is suitable for use of the polyester resin. The circularity of the toner tends to be high in this method so that the toner becomes approximately spherical. However, the toner can be distorted (see, for example, Japanese Patent Application Laid-Open (JP-A) No. 2006-85094).

Meanwhile, it is also known to add a layered compound to the toner as a charge control agent (see, for example, Japanese Patent Application Laid-Open (JP-A) Nos. 2003-515795, 2006-500605, 2006-503313 and 2003-202708)

However, the layered compounds are hardly dispersed with sufficient thinness to adhere to the surface of a toner in these methods, and this may cause the compounds to aggregate. Moreover, when the layered compounds are added to the outer side of the toner afterward, the compounds come off from the toner in a developing process or the like, thereby causing toner filming and the like.

Thus, it is effective to add the layered compounds and a binder resin simultaneously and granulate the mixture to manufacture a toner in the suspension polymerization so that the layered compounds are present inside the toner. In this method, the layered compounds do not come off or cause the aforementioned problems. To further make the layered compounds act sufficiently as a charge control agent, the layered compounds are preferably localized in the vicinity of the outer side of the toner. In addition, it is more preferable that smaller layered compounds be present in the toner.

To achieve this, it is necessary to sufficiently disperse the layered compounds in an organic solvent (i.e., an oil phase) to manufacture a toner in the suspension polymerization. Herein, toner ingredients are dissolved or dispersed in the organic solvent. However, this increases the thixotropy of the oil phase. As widely known, some layered compounds are used as an additive to ink and coating material to advantageously enhance the thixotropy thereof. In the suspension polymerization, on the contrary, the thixotropy of the oil phase is disadvantageously enhanced, and changes are great in volume and shapes of aggregated oil droplets produced by dispersion and granulation in an aqueous phase. Thus, the layered compounds and other ingredients of the toner cannot integrally form one approximately spherical shape, thereby distorting the shape of the toner. Therefore, an approximately spherical toner cannot be obtained, and the layered compounds cannot act sufficiently as a charge control agent.

As generally known, a transfer rate and the image quality are improved as the toner becomes more spherical. Nevertheless, it is difficult to transfer the toner completely, and the residual toner on the photoconductor or the like must be cleaned after the transfer. In conventional blade cleaning, a blade has not been able to capture the residual toner completely because the toner is approximately spherical. Thus, a cleanerless system has been employed to collect and store the residual toner in a developing device or the like or remove the residual toner by a brush, instead of cleaning the residual toner by the conventional blade.

With this system, it is possible to reduce toner waste and the size of an image forming apparatus since a toner waste box or the like is no longer needed. However, it is significantly important to reduce the residual toner as much as possible to employ this system. Therefore, the circularity of the toner should be higher to improve the transfer rate.

Recently, the performance of printers has been improved especially in full-color printers, in terms of speed, life, image quality and the like. Along with this, the quality of the toner needs to be improved. In particular, the chargeability and stability of a toner play important roles in enabling high-speed printing. To improve these, a large number of charge control agents have been studied and tested.

It has been generally considered that a charge control agent on the surface of the toner greatly affects the chargeability. To control the electrification of the toner, a large amount of charge control agent is added to the toner. In the conventional pulverization, a charge control agent, a colorant and other necessary additives are added to a thermoplastic resin serving as a binder resin. The mixture is then melted, kneaded, pulverized and classified to manufacture a toner. In this method, a high-quality image is hardly obtained because there is a limit on reducing particle diameter. Moreover, it is impossible to control ingredient distributions in a particle although the ingredients can be uniformly dispersed in each particle since the pulverization is performed before the kneading. Furthermore, toner filming occurs and the fixability degrades when a charge control agent is added more to enhance the chargeability.

Recently, a modified inorganic layered mineral has been proposed. In this mineral, some interlayer ions are modified by organic ions. However, this has the same problems described above (see, for example, JP-A Nos. 2003-515795, 2006-500605, 2006-503313 and 2003-202708).

### BRIEF SUMMARY OF THE INVENTION

In light of the aforementioned problems, an object of the present invention is to provide a latent electrostatic image developing toner which has sufficient chargeability and excellent durability, achieves low-temperature fixability and thermal resistance and storage stability, and improves image quality with less toner waste when the toner is used in a compact cleanerless image forming apparatus taking up less space. It is also an object of the present invention to provide a developer, a toner container, an image forming apparatus and a process cartridge, which employ the toner.

The inventors of the present invention have studied and investigated the problems and discovered that aspects (1) to (16) of the present invention overcome the problems. The present invention is detailed hereinafter.

(1) A latent electrostatic image developing toner used for a cleanerless image forming method, includes: two or more binder resins; a colorant; a releasing agent; and a layered compound,

wherein the toner is constituted by particles which are prepared by granulation in an aqueous medium, and average circularity of the particles is 0.970 or more,

a first binder resin of the binder resins is a polyester resin with an acid value of 15 KOHmg/g or less, and

the layered compound is a modified layered compound, in which at least some interlayer ions are modified by organic ions.

(2) In the latent electrostatic image developing toner according to (1), a weight ratio of the first binder resin is 50% or more to a total amount of the binder resins.

When the weight ratio of the first binder resin is 50% or more, aggregation of the particles, which are prepared by granulation in the aqueous medium, is suppressed. Thus, approximately spherical particles are reliably obtained with the average circularity of 0.970 or more.

(3) In the latent electrostatic image developing toner according to any one of (1) and (2), the layered compound is a modified inorganic layered mineral, in which at least some interlayer cations are modified by organic cations.

The layered compound becomes less hydrophilic by using the modified inorganic layered mineral, in which at least some interlayer cations are modified by organic cations. Consequently, the minerals are easily incorporated into the particles prepared by granulation in the aqueous medium. Moreover, the minerals are localized in the surface of the particle by the pelletization in granulation, thereby improving the chargeability of the toner.

(4) In the latent electrostatic image developing toner according to any one of (1) to (3), the binder resins contain a modified polyester resin having a urethane and/or urea group.

The binder resins contain the modified polyester resin. This facilitates the adjustment of the molecular weight of polymer components or the like. Thus, the modified polyester resin achieves the low-temperature fixability of the latent electrostatic image developing toner (especially when the toner is used for an oilless toner) and the high fluidity thereof at a fixing temperature, thereby suppressing adhesion of the toner to a fixing heating medium. Since the binder resins contain the modified polyester resin having a urethane and/or urea group, it is possible to adjust the viscoelasticity of the toner and prevent toner offset.

(5) In the latent electrostatic image developing toner according to any one of (1) to (4), the polyester resin contains a modified polyester resin component elongated and/or crosslinked by a reaction between amines and a polyester resin having an isocyanate group at an end.

In the modified polyester such as a urea-modified polyester, the molecular weight of the polymer components can be easily adjusted. Herein, the urea-modified polyester is obtained by reaction of a polyester prepolymer, which has an isocyanate group, with amines. A urea-modified polyester resin, in which an end of a polyester prepolymer is modified by urea, maintains high fluidity and transparency of an unmodified polyester resin at a fixing temperature. Thus, it is possible to prevent adhesion of the toner to the fixing heat medium.

(6) In the latent electrostatic image developing toner according to any one of (1) to (5), an amount of the layered compound contained in the particles ranges from 0.5% by mass to 2.0% by mass.

In the range above, a large number of layered compounds are present (localized) in the surface of the particles so that the chargeability of the toner is improved. By the mutual effects between the layered compounds and the polyester resin (first binder resin) having an acid value of 15 KOHmg/g or less, the toner will not be distorted, and the average circularity of the particles will become 0.970 or more.

(7) In the latent electrostatic image developing toner according to any one of (1) to (6), the toner is constituted by particles prepared by granulation in a manufacturing method which comprises: dispersing and granulating dissolved matter or dispersed matter in the aqueous medium after dissolving or dispersing the binder resins, the colorant, the releasing agent and the layered compound in an organic solvent.

A large number of the layered compounds are localized in the surface of the particles prepared by granulation in the manufacturing method. Thus, the particles have favorable chargeability and become approximately spherical with the average circularity of 0.970 or more. Therefore, the particles have a suitable volume average particle diameter (Dv) and number average particle diameter (Dn).

(8) In the latent electrostatic image developing toner according to any one of (1) to (7), the toner is a negatively-charged nonmagnetic one-component developing toner.

The negatively-charged nonmagnetic one-component developing toner is suitable for the cleanerless image forming apparatus. For example, this toner is suitable for a collecting system of the developing device when the toner is recharged

(10) A two-component developer is constituted by an electrostatic image developing carrier and the latent electrostatic image developing toner according to any one of (1) to (7).

(11) An image forming method includes: forming a latent image; developing the latent image by a toner; transferring; and fixing,

wherein the image forming method excludes a cleaning residual toner on an image carrier by using a blade after the transferring,

the toner contains two or more binder resins, a colorant, a releasing agent and a layered compound,

the toner is constituted by particles which are prepared by granulation in an aqueous medium, and average circularity of the particles is 0.970 or more,

a first binder resin of the binder resins is a polyester resin with an acid value of 15 KOHmg/g or less, and

the layered compound is a modified layered compound, in which at least some interlayer ions are modified by organic ions.

(12) A toner container stores the latent electrostatic image developing toner according to any one of (1) to (8).

(13) An image forming apparatus includes a photoconductor, a charging unit, an exposing unit, a developing unit, a transferring unit and a fixing unit, and the developing unit employs the latent electrostatic image developing toner according to any one of (1) to (8).

(14) In the image forming apparatus according to (13), a fixing member of the fixing unit is a roller provided with a heating device.

The roller is provided with the heating device and performs uniform, stable and continuous fixing. Thus, the roller is enabled to fix the developing image of the latent electrostatic image developing toner of the present invention without causing toner offset and the like.

(15) In the image forming apparatus according to any one of (13) and (14), it is unnecessary to apply oil to the fixing member of the fixing unit.

In this oilless fixing unit, it is unnecessary to provide the fixing unit with a lubricant applying device. Thus, the image forming apparatus can be simplified and made smaller, thereby reducing the manufacturing costs thereof.

(16) A process cartridge used in the image forming apparatus according to any one of (13) to (15) integrally incorporates a photoconductor and at least one selected from a charging unit charging the photoconductor, a developing unit and a cleaning unit except a blade cleaning unit and is detachable from the image forming apparatus.

According to the latent electrostatic image developing toner of the present invention (i.e., particles prepared by granulation in an aqueous medium), the toner contains two or more binder resins, a colorant, a releasing agent and a layered compound (e.g., an inorganic layered mineral, in which at least some interlayer cations are modified by organic cations). The layered compounds are localized in the surface of the particles by the pelletization in the granulation so that sufficient chargeability and durability of the toner are retained. By the mutual effects between the layered compounds and the first binder resin with an acid value of 15 KOHmg/g or less, the particles will not be distorted. As a result, the particles become approximately spherical with the average circularity of 0.970 or more. Thus, the toner is suitably used for the cleanerless image forming apparatus and method. Therefore, it is possible to manufacture a compact image forming apparatus, which takes up less space and generates less toner waste. Moreover, the toner has excellent chargeability and durability and achieves low-temperature fixability and thermal resistance and storage stability. Hence, it is possible to form a stable high-quality image in long-term printing.

According to the one-component developer or the two-component developer of the present invention, both developers can be suitably used for the cleanerless image forming apparatus. The developers have excellent durability, and the chargeability thereof is maintained in long-term printing. Thus, a stable high-quality image with high resolution can be stably formed for an extended period of time.

According to the image forming method of the present invention, it is possible to form a stable high-quality image in long-term printing with less toner waste since the latent electrostatic image developing toner is used.

According to the toner container of the present invention, the container stably contains the toner even when exposed to environmental changes. Thus, the toner can be handled simply and easily, and the apparatus is kept clean.

According to the cleanerless image forming apparatus of the present invention, it is possible to manufacture a compact cleanerless image forming apparatus, which takes up less space. Moreover, the toner used in the apparatus has favorable chargeability and durability and achieves low-temperature fixability and thermal resistance and storage stability. Thus, the image forming apparatus is enabled to form a stable high-quality image with less toner waste for an extended period of time and suitably applied to an oilless fixing system.

According to the process cartridge of the present invention, the process cartridge employs the latent electrostatic image developing toner of the present invention. Thus, it is possible to manufacture a compact process cartridge, which takes up less space and generates less toner waste. Therefore, it is easy to maintain the process cartridge, and the operation costs can be reduced. In addition, a member of each processing unit and a photoconductor are integrally incorporated into the cartridge with high relative positional accuracy. This improves the image quality.

It is another object of the present invention to provide a latent electrostatic image developing toner and a process cartridge therefor. The toner has excellent chargeability, environmental stability and stable durability so that a favorable print can be obtained without a background smear or adhesion.

The inventors of the present invention have studied and investigated the aforementioned problems. As a result, the inventors have created the present invention. It is still another object of the present invention is to provide a toner and an image forming apparatus described hereinafter.

(17) In a toner constituted by a colorant, a binder resin, a releasing agent and a modified inorganic layered mineral in which at least some interlayer ions are modified by organic ions, a volume average particle diameter ranges from 4 μm to 8 μm, and the modified inorganic layered mineral occupies 70% of a region 50 nm apart from a periphery of the toner in a backscattered electron image of a cross-section of the toner, taken by a thermal FE-SEM.

(18) In the toner according to (17), the modified inorganic layered mineral is prepared by modifying at least some interlayer cations by organic cations.

(19) In the toner according to any one of (17) and (18), the toner is obtained in granulation by dissolving and/or dispersing toner ingredients containing a binder resin and/or a binder resin precursor, and dispersing and/or emulsifying the obtained solution and/or dispersion liquid (oil phase) in an aqueous medium.

(20) In the toner according to (19), the solution or the dispersion liquid contains 0.05% by mass to 2% by mass of the inorganic layered mineral, in which at least some interlayer ions are modified by organic ions, in the solid content of the solution or the dispersion liquid.

(21) In the toner according to any one of (17) to (20), the toner is obtained by removing the organic solvent after the particles are formed in the aqueous medium.

(22) In the toner according to any one of (17) to (21), the toner is obtained by washing the particles in a washing aqueous medium after the particles are formed in the aqueous medium and drying the particles thereafter.

(23) In the toner according to any one of (17) to (22), the binder resin is a polyester resin with a glass transition temperature of 40° C. or more.

(24) In the toner according to any one of (17) to (23), the binder resin contains a polyester resin elongated by urethane and/or urea bonds.

(25) In the toner according to (24), the polyester resin contains a polyester resin ingredient formed by a reaction between amines and a modified polyester resin having an isocyanate group at an end.

(26) In the toner according any one of (17) to (25), the circularity of the toner is 0.95 or more and less than 0.99.

(27) In the toner according to any one of (17) to (26), the releasing agent contains one or more selected from paraffin, synthetic ester, polyolefin, carnauba wax and rice wax.

(28) In the toner according to any one of (17) to (27), the toner contains a charge control agent.

(29) In the toner according to any one of (17) to (28), the toner is a nonmagnetic one-component developing toner.

(30) An image forming apparatus employs the nonmagnetic one-component developing toner according to (29) of the present invention.

(31) In the image forming apparatus according to (30) of the present invention, the image forming apparatus is a multi-color image forming apparatus.

(32) In the image forming apparatus according any one of (30) and (31), the image forming apparatus has an endless intermediate transferring unit.

(33) In the image forming apparatus according to any one of (30) to (32), the photoconductor and/or the intermediate transferring unit of the image forming apparatus are/is not provided with a blade serving as a residual toner cleaning unit.

(34) In the image forming apparatus according to any one of (30) to (32), the image forming apparatus has a blade cleaning unit.

(35) In the image forming apparatus according to any one of (30) to (34), the image forming apparatus has a roller which is provided with a heating device and serves as the fixing unit.

(36) In the image forming apparatus according to any one of (30) to (34), the image forming apparatus has a belt which is provided with a heating device and serves as the fixing unit.

(37) In the image forming apparatus according to any one of (30) to (34), the image forming apparatus has an oilless fixing unit which does not require oil application to the fixing member.

(38) A toner container stores the toner according to any one of (17) to (29).

(39) A toner container stores the nonmagnetic one-component developing toner according to (29).

(40) A process cartridge integrally incorporates a developing unit and at least one selected from an image carrier, a charging unit and a cleaning unit and is detachable from the image forming apparatus. The developing unit stores the toner according to any one of (17) and (29).

According to the present invention, it is possible to provide a toner and a process cartridge therefor. This toner has excellent chargeability, environmental stability and stable durability and is enabled to obtain a favorable print without a background smear or adhesion.

### BRIEF DESCRIPTION OF THE SEVERAL VIEWS OF THE DRAWINGS

FIG. 1 is a schematic cross-sectional view showing a structure of a latent electrostatic image developing toner of the present invention.

FIG. 2 is a schematic view showing an example of the configuration of a process cartridge of the present invention.

FIG. 3 is a schematic view showing a fixing device used for evaluation of the separatability of Examples.

FIG. 4 is a schematic view showing a cleanerless image forming apparatus used in the present invention.

### DETAILED DESCRIPTION OF THE INVENTION

As previously mentioned, a latent electrostatic image developing toner used for a cleanerless image forming method includes: two or more binder resins; a colorant; a releasing agent; and a layered compound,

wherein the toner is constituted by particles which are prepared by granulation in an aqueous medium, and the average circularity of the particles is 0.970 or more,

a first binder resin of the binder resins is a polyester resin with an acid value of 15 KOHmg/g or less, and

the layered compound is a modified layered compound in which at least some interlayer ions are modified by organic ions.

Herein, the latent electrostatic image developing toner according to the present invention is used suitably and especially in a compact cleanerless image forming apparatus which takes up less space. Thus, it is possible to reduce toner waste and improve the image quality.

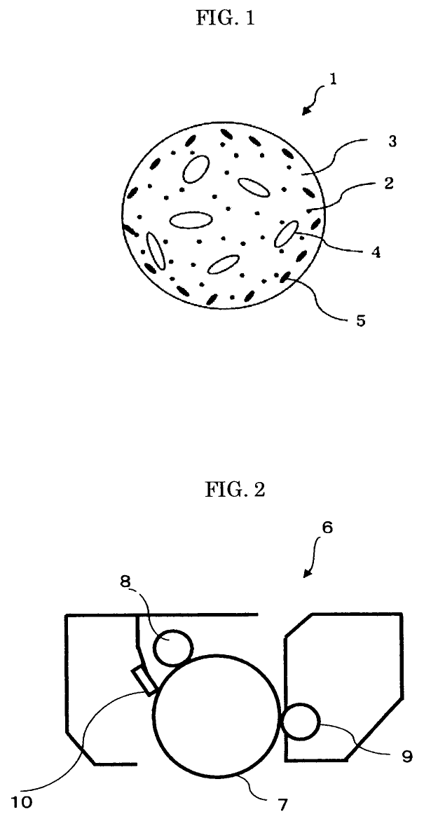

A latent electrostatic image developing toner (hereinafter, may be referred to as “toner”) of the present invention is described with reference to the drawings. FIG. 1 is a schematic cross-sectional view showing a structure of the latent electrostatic image developing toner of the present invention.

As shown in FIG. 1, a toner 1 of the present invention contains a colorant 2, a binder resin 3 (composed of two or more binder resins), a releasing agent 4 and a layered compound 5 (an inorganic layered mineral in which at least some interlayer ions are modified by organic ions). The toner is approximately spherical with the average circularity of 0.970 or more. The layered compounds are localized in the surface of a particle by the pelletization in granulation.

Moreover, the toner of the present invention is constituted by a colorant, a binder resin, a releasing agent and an inorganic layered mineral in which at least some interlayer ions are modified by organic ions. The volume average particle diameter ranges from 4 μm to 8 μm. In a backscattered electron image of the toner cross-section taken by a thermal field emission scanning electron microscope (FE-SEM), the modified inorganic layered mineral occupies 70% of a region 50 nm apart from the periphery of the toner.

As described above, in the backscattered electron image of the toner cross-section taken by the field emission scanning electron microscope (FE-SEM), the modified inorganic layered mineral occupies 70% of the region 50 nm apart from the periphery of the toner. Thus, the modified inorganic layered minerals are localized in the surface of the toner. As a result, the toner has excellent chargeability, environmental stability and stable durability, and prevents a background smear and adhesion.

The modified inorganic layered mineral is prepared by modifying a favorable hydrophilic mineral with organic ions. Accordingly, the modified inorganic layered mineral becomes moderately hydrophobic. When the modified inorganic layered mineral is granulated in an aqueous medium, the modified inorganic layered minerals are likely to be present on the interface of the liquid droplets dispersed in the aqueous medium. Thus, the minerals are localized in the surface of the obtained toner. This presumably prevents wax to be exposed on the surface, thereby preventing adhesion of the wax to a photoconductor and other members in long-term printing or the like. Therefore, the image quality does not degrade.

The area, which is occupied by the modified layered organic mineral in the vicinity of the toner surface, can be measured by the FE-SEM described later.

### <Layered Compound>

An inorganic layered mineral is an inorganic mineral in which several nm-thick layers are superimposed. The word “modify” means to substitute some metal ions with organic ions. Specific examples of the inorganic layered mineral are disclosed in JP-B Nos. 2006-500605 and 2006-503313 and JP-A No. 2003-202708. This structure of the mineral is broadly classified as “intercalation.”

A smectite group (e.g., montmorillonite and saponite), a kaoline group (e.g., kaolinite), magadiite and kanemite are known as inorganic layered minerals.

The inorganic layered mineral is highly hydrophilic because of its layered structure. If an unmodified inorganic layered mineral is dispersed in an aqueous medium and monomers are polymerized to prepare particles (fine resin particles), the inorganic layered mineral moves to the aqueous medium, and the fine resin particles cannot contain a sufficient amount of the mineral. By modifying the inorganic layered mineral (modifying interlayer ions by organic ions), the mineral becomes less hydrophilic and easily moves into the monomer. Thus, the inorganic layered mineral pelletized by dispersion is enabled to favorably adjust charge amount of the particles. When the modified inorganic mineral is pelletized in the preparation of fine resin particles, a large number of the minerals are present (localized) in the surface of the fine resin particles, thereby improving the chargeability of the toner.

Herein, an amount of the layered compound contained in the particle preferably ranges from 0.5% by mass to 2.0% by mass. When the amount is less than 0.5% by mass, the layered compounds are not sufficiently localized in the surface of the particle, and the required chargeability (charge amount of 25 μC/g or more) is not obtained. On the contrary, when the amount exceeds 2.0% by mass, the layered compound easily come off in the developing process or the like, thereby causing toner filming or the like.

The modified inorganic mineral used in the present invention is preferably inorganic mineral with a basic smectite crystal structure modified by organic cations. In addition, some divalent metals of the inorganic layered mineral may be substituted with trivalent metals to introduce metal anions. However, the hydrophilicity becomes high when the metal anions are introduced. Thus, the inorganic layered compound, in which at least some metal anions are modified by organic anions, is preferable.

Quaternary alkyl ammonium salts, phosphonium salts, imidazolium salts or the like may be used as an organic ion modifier for the inorganic layered mineral, in which at least some interlayer ions are modified by organic ions. Among these salts, quaternary alkyl ammonium salts are more preferable.

Examples of the quaternary alkyl ammonium include trimethylstearyl ammonium, dimethylstearylbenzyl ammonium, dimethyloctadecyl ammonium and oleyl bis(2-hydroxyethyl) methyl ammonium.

Examples of the organic ion modifier include sulfates, sulfonates, carboxylates and phosphates, which have branched, linear, or cyclic alkyl (C1 to C44), alkenyl (C1 to C22), alkoxy (C8 to C32), hydroxylalkyl (C2 to C22), ethylene oxide and/or propylene oxide. Among these, carboxylates with an ethylene oxide skeleton is preferable.

Any inorganic layered mineral, in which some interlayer ions are modified by organic ions, may be selected as needed. Examples of the inorganic layered mineral include montmorillonite, bentonite, hectorite, attapulgite, sepiolite and mixtures thereof. Among these, organically modified montmorillonite and bentonite are more preferable to be contained in fine resin particles to improve the chargeability and durability thereof.

Examples of commercial products of the inorganic layered mineral, in which at least some interlayer ions are modified by organic cations, include quaternium 18 bentonites such as BENTONE 3, BENTONE 38 and BENTONE 38V (manufactured by Rheox Corporation), TIXOGELVP (manufactured by United Catalyst Corporation), CLAYTONE 34, CLAYTONE 40 and CLAYTONE XL (manufactured by Southern Clay Products Inc.); stearalkonium bentonites such as BENTONE 27 (manufactured by Rheox Corporation), TIXOGEL LG (manufactured by United Catalyst Corporation), and CLAYTONE AF and CLAYTONE APA (manufactured by Southern Clay Products Inc.); and quaternium 18/benzalkonium bentonites such as CLAYTONE HT and CLAYTONE PS (manufactured by Southern Clay Products Inc.). Among these, CLAYTONE AF and CLAYTONE APA are particularly preferable.

Meanwhile, as the inorganic layered mineral in which some interlayer ions are modified by organic anions, DHT-4A (manufactured by Kyowa Hakko Kogyo Co., Ltd.) modified by organic anions of a compound represented by a General Formula (1) below, is particularly preferable. An example of the compound represented by the General Formula (1) is Hytenol 330T (manufactured by Dai-ichi Kogyo Seiyaku Co., Ltd):

R₁(OR₂)ₙOSO₃M General Formula (1)

where R₁ is an alkyl group having 13 carbon atoms, R₂ is an alkylene group having 2 to 6 carbon atoms, n is an integer 2 to, 10 and M is a monovalent metal element.

(Shape of Toner)

It is preferable that a toner become more spherical. As the toner becomes more spherical, the mobility thereof improves, thereby causing less tiny dots on an image and improving the image quality such as image reproducibility. Specifically, the average circulatiry of the latent electrostatic image developing toner used in the cleanerless image forming apparatus is preferably 0.97 or more, more preferably 0.975 or more and further preferably 0.98 or more. The average circularity can be measured by the following method.

(Average Circularity)

To measure the circularity, a suspension containing particles is subjected to pass through a flat image pickup detection zone, a CCD camera optically detects an image of the particles, and the particles are optically analyzed. The average circularity is represented by a value obtained by dividing the circumference of an equivalent circle having the same area as the projected area obtained in this method by the circumference of an existing particle.

This value is calculated as the average circularity based on the results obtained from a flow particle image analyzer, FPIA-2000. Specifically, 0.1 ml to 0.5 ml of a surfactant (preferably, benzene sulfonate) serving as a dispersant is added to 100 ml to 150 ml of water in a container. Herein, solid impurities are removed from the water beforehand. Further, approximately 0.1 g to 0.5 g of a target sample is added. The obtained suspension with the dispersed sample is subjected to dispersion for approximately 1 minute to 3 minutes by an ultrasonic disperser. The concentration of the dispersion liquid is set to 3,000 to 10,000 particle/μl, and the circularity and distribution of the toner can be measured by the device.

### <Binder Resin>

In the present invention, the toner contains two or more binder resins as its constituents. A first binder resin of the binder resins has a polyester skeleton with an acid value of 15 KOHmg/g or less.

In other words, a polyester resin is preferably used to constitute the toner to achieve the fixability and thermal resistance and storage stability. A small amount of a vinyl copolymer resin such as a styrene-acrylic resin may be added since it is easy to design the properties of the vinyl copolymer, such as the thermal properties and polarity, and to polymerize the vinyl copolymer resin with a monomer having a specific functional group.

### [Polyester Resin]

An example of the polyester resin used in the present invention is a polycondensate of polyols (1) and polycarboxylic acids (2) described below. Any of these may be used. In addition, several kinds of polyester resins may be mixed with the polycondensate to be used. However, it is preferable to use a first binder resin having a polyester skeleton with an acid value of 15 KOHmg/g or less as described above. The detailed mechanism has not been unraveled yet, but an approximately spherical toner containing the layered compound can be obtained by using these resins. Note that, if a resin with a high acid value is used, the toner is distorted and an approximately spherical toner can be hardly obtained.

(Polyol)

Examples of the polyols (1) include alkylene glycols (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexanedimethanol and hydrogenated bisphenol A); bisphenols (e.g., bisphenol A, bisphenol F and bisphenol S); 4,4′-dihydroxybiphenyls (e.g., 3,3′-difluoro-4,4′-dihydroxybiphenyl); bis(hydroxyphenyl) alkanes (e.g., bis(3-fluoro-4-hydroxyphenyl) methane, 1-phenyl-1,1-bis(3-fluoro-4-hydroxyphenyl)ethane, 2,2-bis(3-fluoro-4-hydroxyphenyl propane, 2,2-bis(3,5-difluoro-4-hydroxyphenyl) propane (also known as tetrafluorobisphenol A) and 2,2-bis(3-hydroxyphenyl)-1,1,1,3,3,3-hexafluoropropane); bis(4-hydroxyphenyl)ethers (e.g., bis(3-fluoro-4-hydroxyphenyl) ether);

adducts of the abovementioned alicyclic diols with alkylene oxides (e.g., ethylene oxide, propylene oxide and butylene oxide); and
adducts of the abovementioned bisphenols with alkylene oxides (e.g., ethylene oxide, propylene oxide and butylene oxide).

Among these compounds, alkylene glycols having 2 to 12 carbon atoms and adducts of a bisphenol with alkylene oxides are preferable. Adducts of a bisphenol with an alkylene oxide, and mixtures thereof with an alkylene glycol having from 2 to 12 carbon atoms are particularly preferable.

Examples of the polyols further include multivalent aliphatic alcohols having 3 or more valences (e.g., glycerin, trimethylolethane, trimethylolpropane, pentaerythritol and sorbitol); phenols having 3 or more valences (e.g., trisphenol PA, phenolnovolak, cresolnovolak); and adducts of the abovementioned polyphenols having 3 or more valences with an alkylene oxide.

Note that the polyols described above may be used alone or in combination and are not limited to these polyols.

(Polycarboxylic Acid)

Examples of the polycarboxylic acid (2) include alkylene dicarboxylic acids (e.g., succinic acid, adipic acid and sebacic acid); alkenylene dicarboxylic acids (e.g., maleic acid and fumaric acid); and aromatic dicarboxylic acids (e.g., phthalic acid, isophthalic acid, terephthalic acid, naphthalene dicarboxylic acid, 3-fluoroisophthalic acid, 2-fluoroisophthalic acid, 2-fluoroterephthatlic acid, 2,4,5,6-tetrafluoroisophathalic acid, 2,3,5,6-tetrafluoroterephthalic acid, 5-trifluoromethylisophthalic acid, 2,2-bis(4-carboxyphenyl) hexafluoropropane, 2,2-bis(3-carboxyphenyl) hexafluoropropane, 2,2′-bis(trifluoromethyl)-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid and hexafluoroisopropylidenediphthalic anhydride).

Among these compounds, alkenylene dicarboxylic acids having 4 to 20 carbon atoms and aromatic dicarboxylic acids having 8 to 20 atoms are preferable. Examples of the polycarboxylic acids having 3 or more valences include aromatic polycarboxylic acids having 9 to 20 carbon atoms (e.g., trimellitic acid and pyromellitic acid). The abovementioned acid anhydride or lower alkyl esters (e.g., methyl ester, ethyl ester and isopropyl ester) may be used to react with the polyols (1). Note that the abovementioned polycarboxylic acids may be used alone or in combination and are not limited to these polycarboxylic acids.

(Ratio of Polyol to Polycarboxylic Acid)

A ratio of a polyol (1) to a polycarboxylic acid (2) is normally 2/1 to 1/1, preferably 1.5/1 to 1/1, and more preferably 1.3/1 to 1.02/1 in the equivalent ratio [OH]/[COOH] of the hydroxyl group [OH] to the carboxylic group [COOH].

(Molecular Weight of Polyester Resin)

The peak molecular weight of the polyester resin ranges normally from 1,000 to 30,000, preferably from 1,500 to 10,000, and more preferably from 2,000 to 8,000. When the peak molecular weight is less than 1,000, the thermal resistance and storage stability deteriorate. When the peak molecular weight is more than 30,000, the low-temperature fixability degrades. The molecular weight can be measured as described hereinafter.

(Molecular Weight)

The molecular weights of the polyester resin, the vinyl copolymer resin and the like were measured by typical gel permeation chromatography (GPC) under the following conditions:

Apparatus: HLC-8220GPC (manufactured by Tosoh Corporation)

Column: TSKgel SuperHZM-Mx3

Temperature: 40° C.

Solvent: Tetrahydrofuran (THF)

Flow Rate: 0.35 ml/min.

Sample: 0.01 ml of samples with concentrations ranging from 0.05% to 0.6% was infused.

The weight average molecular weight Mw was calculated from the molecular weight distribution of the toner resin measured under the above conditions by using a calibration curve of the molecular weight created based on monodispersed polystyrene reference samples. 10 different monodispersed polystyrene reference samples were used with a molecular weight of 5.8×100, 1.085×10000, 5.95×10000, 3.2×100000, 2.56×1000000, 2.93×1000, 2.85×10000, 1.48×100000, 8.417×100000 and 7.5×1000000.

[Modified Polyester Resin]

The binder resins used in the present invention may contain a modified polyester resin, which has a urethane and/or urea group, to adjust the viscoelasticity so that the toner offset and the like are prevented.

By containing the modified polyester resin having a urethane and/or urea group, it is possible to adjust the viscoelasticity and prevent toner offset and the like. In addition, this achieves the low-temperature fixability of the latent electrostatic image developing toner (especially when the toner is used in an oilless fixing device) and the high fluidity thereof at a fixing temperature, thereby suppressing adhesion of the toner to a fixing heat medium.

An amount of modified polyester resin having a urethane and/or urea group contained in the binder resins is preferably 20% or less, more preferably 15% or less, and further preferably 10% or less. When the amount exceeds 20%, the low-temperature fixability degrades. The modified polyester resin having the urethane and/or urea group may be directly mixed with the binder resins. To manufacture the toner, the modified polyester resin (hereinafter may be referred to as “prepolymer”) and amine are preferably mixed with the binder resins so that a modified polyester resin having a urethane and/or urea group is prepared by elongation and/or crosslinking in/after the granulation. Herein, the prepolymer has an isocyanate group at an end and a relatively low molecular weight, and the amines react with the prepolymer. In this method, a modified polyester resin with a relatively high molecular weight can be easily contained in the core of the binder resins to adjust the viscoelasticity.

(Prepolymer)

Examples of the prepolymers having an isocyanate group include compounds prepared by reacting polyesters with polyisocyanates (3). Herein, the polyesters are polycondensates of the polyols (1) and polycarboxylic acids (2) and have an active hydrogen group. Examples of the active hydrogen group of the polyester include a hydroxyl group (e.g., an alcoholic hydroxyl group and a phenolic hydroxyl group), an amino group, a carboxyl group and a mercapto group. Among these, the alcoholic hydroxyl group is preferable.

(Polyisocyanate)

Examples of the polyisocyanates (3) include aliphatic polyisocyanates (e.g., tetramethylenediisocyanate, hexamethylenediisocyanate and 2,6-diisocyanatomethylcaproate); alicyclic polyisocyanates (e.g., isophoronediisocyanate and cyclohexylmethanediisocyanate); aromatic diisocyanates (e.g., tolylenediisocyanate and diphenylmethanediisocyanate); aromatic aliphatic diisocyanates (e.g., α,α,α′,α′-tetramethylxylylenediisocyanate); isocyanurates; the abovementioned polyisocyanates blocked with phenol derivatives, oxime and caprolactam; and combinations thereof.

(Ratio of Isocyanate Group to Hydroxylic Group)

A ratio of the polyisocyanates (3) is normally 5/1 to 1/1, preferably 4/1 to 1.2/1, and more preferably 2.5/1 to 1.5/1 in the equivalent ratio [NCO]/[OH] of the isocyanate group [NCO] to the hydroxyl group [OH] of the polyester having a hydroxyl group. When the ratio [NCO]/[OH] exceeds 5, the low-temperature fixability deteriorates. When the molar ratio of [NCO] is less than 1, an amount of the urea contained the modified polyester resin decreases, and the toner offset resistance degrades.

An amount of the polyisocyanate (3) components in the prepolymer (A) having a isocyanate group at an end ranges normally from 0.5% by mass to 40% by mass, preferably from 1% by mass to 30% by mass, and more preferably from 2 by mass to 20% by mass. When the amount is less than 0.5% by mass, the toner offset resistance deteriorates. When the amount exceeds 40% by mass, the low-temperature fixability degrades.

(Number of Isocyanate Groups in Prepolymer)

The number of the isocyanate groups contained in a molecule of the prepolymer (A) is normally 1 or more, preferably from 1.5 to 3 on average, and more preferably from 1.8 to 2.5 on average. When the number of isocyanate groups is less than 1 per molecule, the molecular weight of the modified polyester after elongation and/or crosslinking decreases, and the toner offset resistance degrades.

(Chain Elongation and/or Crosslinking Agent)

Amines may be used as a chain elongation and/or crosslinking agent in the present invention. Examples of the amines (B) include diamines (B1), polyamines (B2) having three or more valences, amino alcohols (B3), amino mercaptans (B4), amino acids (B5) and blocked amines (B6) in which the amino groups in the amines (B1) to (B5) are blocked.

Examples of the diamines (B1) include aromatic diamines (e.g., phenylene diamine, diethyltoluene diamine, 4,4′-diaminodiphenyl methane, tetrafluoro-p-xylylene diamine and tetrafluoro-p-phenylene diamine); alicyclic diamines (e.g., 4,4′-diamino-3,3′-dimethyldicyclohexyl methane, diaminocyclo hexane and isophorone diamine); and aliphatic diamines (e.g., ethylene diamine, tetramethylene diamine, hexamethylene diamine, dodecafluorohexylene diamine and tetracosafluorododecylene diamine).

Examples of the polyamines (B2) having three or more valences include diethylene triamine and triethylene tetramine.

Examples of the amino alcohols (B3) include ethanol amine and hydroxyethyl aniline.

Examples of the amino mercaptans (B4) include aminoethyl mercaptan and aminopropyl mercaptan.

Examples of the amino acids (B5) include amino propionic acid and amino caproic acid.

Examples of the blocked amines (B6) include ketimine compounds which are prepared by reacting the abovementioned amines (B1) to (B5) with ketones (e.g., acetone, methyl ethyl ketone and methyl isobutyl ketone), and oxazoline compounds.

(Reaction Terminator)

The molecular weight of the modified polyester resin can be optionally controlled using a reaction terminator for elongation and/or crosslinking. Examples of the reaction terminator include monoamines (e.g., diethyl amine, dibutyl amine, butyl amine and lauryl amine) and blocked amines such as ketimine compounds prepared by blocking these monoamines.

(Ratio of Amino Group to Isocyanate Group)

A ratio of amines (B) is normally 1/2 to 2/1, preferably 1.5/1 to 1/1, and more preferably 1.2/1 to 1/1.2 in the equivalent ratio [NCO]/[NHx] of the isocyanate group [NCO] in the prepolymer (A) having an isocyanate group to the amino group [NHx] in the amine (B). When the equivalent ratio [NCO]/[NHx] exceeds 2 or less than ½, the molecular weight of the urea-modified polyester (i) decreases, thereby degrading the toner hot offset resistance.

### <Colorant>

Examples of the colorant of the present invention include any known dyes and pigments such as carbon black, Nigrosine dyes, black iron oxide, NAPHTHOL YELLOWS, HANSA YELLOW (10G, 5G and G), Cadmium yellow, yellow iron oxide, ocher, chrome yellow, Titan Yellow, polyazo yellow, Oil Yellow, HANSA YELLOW (GR, A, RN and R), Pigment Yellow L, BENZIDINE YELLOW (G and GR), PERMANET YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc white and lithopone. These colorants can be used alone or in combination. An amount of a colorant contained in the toner ranges normally from 1% by mass to 15% by mass, and more preferably from 3% by mass to 10% by mass.

[Colorant Masterbatch]

The colorant for use in the present invention can be combined with a resin to be used as a masterbatch.

Examples of the binder resin used to manufacture the masterbatch include the aforementioned modified and unmodified polyester resins, styrene polymers and substituted styrene polymers (e.g., polystyrenes, poly-p-chlorostyrenes and polyvinyltoluenes), styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl-α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers), polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylate resins, rosins, modified rosins, terpene resins, aliphatic or alicyclic hydrocarbon resins, aromatic petroleum resins, chlorinated paraffins and paraffin waxes. These resins can be used alone or in combination.

(Preparation of Masterbatch)

The masterbatch can be prepared by mixing and kneading the resins and the colorant while a high shear force is applied thereto. An organic solvent may be used to enhance the interaction between the colorant and the resins. Moreover, a flushing method is preferably used. In the flushing method, an aqueous paste containing water with the colorant is mixed and kneaded with the resins and the organic solvent so that the colorant is moved to the resin, and the water and the organic solvent are removed. Thus, it is not necessary to dry the wet cake of the colorant. Therefore, the flushing method is preferably used. To mix and knead, a high shear disperser such as a three roll mill is preferably used.

### <Releasing Agent>

Any known releasing agents can be used for the toner of the present invention. Examples of the releasing agents include polyolefin waxes (e.g., polyethylene waxes and polypropylene waxes), hydrocarbons having a long chain (e.g., paraffin waxes and SASOL waxes), and waxes containing a carbonyl group. Examples of the waxes containing a carbonyl group include alkanoate esters (e.g., carnauba wax, montan wax, trimethylolpropane tribehenate, pentaerythritol tetrabehenate, pentaerythritol diacetate dibehenate, glycerin tribehenate and 1,18-octadecanediol distearate); polyalkanol esters (e.g., tristearyl trimellitate and distearyl maleate); polyalkanoic acid amides (e.g., ethylenediamine dibehenyl amide); polyalkylamides (e.g., acid tristeary trimelliate); and dialkyl ketones (e.g., distearyl ketone). Among these waxes containing a carbonyl group, alkanoate esters are preferable.

### <External Additive>

### (Fine Inorganic Particles)

Fine inorganic particles may be preferably used as an external additive to improve the fluidity, developability and chargeability of the (colorant) particles prepared by granulation according to the present invention. The fine inorganic particles have a primary particle diameter ranging preferably from 5 nm to 2 μm, and more preferably from 5 nm to 500 nm. The fine inorganic particles preferably have a BET specific surface area ranging from 20 m²/g to 500 m²/g. An amount of the fine inorganic particles contained in the toner preferably ranges from 0.01% by mass to 5.0% by mass, and more preferably from 0.01% by mass to 2.0% by mass.

Specific examples of the fine inorganic particles include silica, alumina, titanium oxide, barium titanate, magnesium titanate, calcium titanate, strontium titanate, zinc oxide, tin oxide, silica sand, clay, mica, wollastonit, diatomite, chromium oxide, cerium oxide, red iron oxide, antimony trioxide, magnesium oxide, zirconium oxide, barium sulfate, barium carbonate, calcium carbonate, silicon carbide and silicon nitride.

(Fine Polymer Particles)

Other fine polymer particles may be obtained from, for example, polystyrenes, methacrylates and acrylate copolymers which are prepared by soap-free emulsion polymerization, suspension polymerization or dispersion polymerization; polymers such as silicone, benzoguanamine and nylon which are prepared by polycondensation; and thermosetting resins.

(Surface Treatment of External Additive)

The external additives are preferably subjected to surface treatment by a plasticizer (finishing agent) to enhance the hydrophobicity of the toner. This prevents the toner to degrade in terms of its fluidity and chargeability even under high humidity. Examples of the preferred finishing agent include silane coupling agents, silylation agents, silane coupling agents having a fluorinated alkyl group, organic titanate coupling agents, aluminum coupling agents, silicone oils and modified silicone oils.

### <Charge Controlling Agent>

The toner of the present invention may optionally contain a charge controlling agent as needed. Examples of the charge controlling agent include any known charge controlling agents such as Nigrosine dyes, triphenylmethane dyes, metal complex dyes containing chromium, molybdate chelate pigments, Rhodamine dyes, alkoxyamines, quaternary ammonium salts (including fluorine-modified quaternary ammonium salts), alkylamides, phosphorous monomers and compounds, tungsten monomers and compounds, fluorine activators, metal salts of salicylic acid and metal salts of salicylic acid derivatives. Specific examples of the charge controlling agent include BONTRON N-03 (Nigrosine dyes), BONTRON P-51 (quaternary ammonium salt), BONTRON S-34 (metal-containing azo dye), BONTRON E-82 (metal complex of oxynaphthoic acid), BONTRON E-84 (metal complex of salicylic acid) and BONTRON E-89 (phenolic condensation product), which are manufactured by Orient Chemical Industries Co., Ltd.; TP-302 and TP-415 (molybdenum complexes of quaternary ammonium salt), which are manufactured by Hodogaya Chemical Co., Ltd.; COPY CHARGE PSY VP2038 (quaternary ammonium salt), COPY BLUE PR (triphenyl methane derivative), COPY CHARGE NEG VP2036 and COPY CHARGE NX VP434 (quaternary ammonium salts), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group or a quaternary ammonium salt.

(Cleaning Aid)

A cleaning aid can be used to remove a developer remaining on a latent electrostatic image bearing member or a primary transferring medium after the transfer. Examples of the cleaning aid include fatty acids and metal salts thereof such as zinc stearate, calcium stearate and stearic acid; and fine polymer particles obtained from polymethyl methacrylate and polystyrene, which are manufactured by soap-free emulsion polymerization or the like. It is preferable that fine polymer particles have a relatively narrow particle size distribution and a volume average particle diameter ranging from 0.01 μm to 1 μm.

[Toner Manufacturing Method]

The toner according to the present invention is preferably manufactured by the following method, but the method is not limited thereto.

A preferred manufacturing method of the toner according to the present invention includes dissolving or dispersing two or more binder resins (a first binder resin is a polyester resin), a colorant, a releasing agent and a layered compound and dispersing and granulating the dissolved matter or the dispersed matter in an aqueous medium. The toner manufacturing method is detailed hereinafter.

[Preparation of Toner Particles by Granulation]

(Organic Solvent)

The organic solvent (oil phase) contains two or more binder resins (a first binder resin is a polyester resin), a colorant, a releasing agent and a layered compound as its components. The organic solvent is preferably volatile with a boiling point of 100° C. or less so that the solvent can be easily removed afterward. Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These organic solvents can be used alone or in combination. In particular, it is preferably to use ester solvents such as methyl acetate and ethyl acetate, aromatic solvents such as toluene and xylene, and halogenated hydrocarbons such as methylene chloride, 1,2-dichloroethane, chloroform and carbon tetrachloride.

Two or more binder resins containing a polyester resin, a colorant, a releasing agent and a layered compound may be dissolved or dispersed simultaneously. However, each component is normally dissolved or dispersed separately in the same or different organic solvents, but it is preferable to use the same kind of solvent so as to be easily removed afterward.

(Dissolving and Dispersing Polyester Resin)

The solution or dispersion liquid of the polyester resin preferably has a resin concentration ranging from approximately 40% to 80%. When the resin concentration is extremely high, it is difficult to dissolve or disperse the resin, and the viscosity of the solution or dispersion liquid becomes high. When the concentration is extremely low, less toner is manufactured. The modified polyester resin, which has an isocyanate group at an end, may be mixed with the polyester resin in the same or different solution or dispersion liquid. In terms of solubility and viscosity, it is preferable to use different solutions or dispersion liquid.

(Dissolving or Dispersing Colorant)

The colorant may be dissolved or dispersed in the solvent alone or in the solution or dispersion liquid of the polyester resin. A dispersion aid and/or polyester resin may be optionally added. In addition, the aforementioned masterbatch of the colorant may be used.

(Dissolving or Dispersing Releasing Agent)

To dissolve wax or disperse wax, a releasing agent, in a wax-insoluble organic solvent, the organic solvent is used as a dispersion liquid. The dispersion liquid is prepared by a typical method.

Specifically, the organic solvent and wax are mixed and dispersed by a disperser such as a bead mill. After the organic solvent and wax are mixed, the mixture is heated to a melting point of the wax. The mixture is cooled down by stirring and dispersed by a disperser such as a bead mill. In this method, it could take less time to disperse. Different kinds of wax may be mixed to be used, and a disperse aid and/or a polyester resin may be added.

(Dispersing Modified Inorganic Layered Compound)

The modified inorganic layered mineral can be mixed with the solution or dispersion liquid of the binder resins. Alternatively, the modified inorganic layered mineral may be mixed with the binder resins, fused, kneaded and pulverized to be used as a masterbatch.

(Aqueous Medium)

Water alone or water and a water-miscible solvent may be used as an aqueous medium. Examples of the water-miscible solvent include alcohols (e.g., methanol, isopropanol and ethylene glycol), dimethylformamide, tetrahydrofuran, cellosolves (e.g., methyl cellosolve) and lower ketones (e.g., acetone and methyl ethyl ketone).

An amount of the aqueous medium to 100 parts by mass of the toner ingredients ranges normally from 50 parts by mass to 2,000 parts by mass, and preferably from 100 parts by mass to 1,000 parts by mass. When the amount is less than 50 parts by mass, the toner ingredients are not sufficiently dispersed, and toner particles cannot be obtained with a predetermined diameter. When the amount exceeds 2,000 parts by mass, the manufacturing costs increase.

(Inorganic Dispersant and Fine Organic Resin Particles)

To disperse dissolved or dispersed toner ingredients in the aqueous medium, it is preferable to disperse an inorganic dispersant or fine organic resin particles so that the toner particles have a sharp particle size distribution and the dispersion is stably performed.

Examples of the inorganic dispersant include tricalcium phosphate, calcium carbonate, titanium oxide, colloidal silica and hydroxyapatite.

Any resins can be used to form fine organic resin particles as long as aqueous dispersoids can be formed. The resins may be thermoplastic or thermosetting. Examples of the resins include vinyl resins, polyurethane resins, epoxy resins, polyester resins, polyamide resins, polyimide resins, silicon resins, phenol resins, melamine resins, urea resins, aniline resins, ionomer resins and polycarbonate resins. These resins may be used alone or in combination. Among these resins, vinyl resins, polyurethane resins, epoxy resins, polyester resins and combinations thereof are preferably used because these resins can easily form aqueous dispersoids of the fine spherical resin particles.

### (Dispersing Fine Organic Resin Particles to Aqueous Medium)

Suitable methods (a) to (h) for forming an aqueous dispersion liquid of the organic resin particulates are described hereinafter but are not limited thereto.

(a) When the resin is a vinyl resin, an aqueous dispersion liquid of the resin particles is directly manufactured by polymerization reaction (e.g. suspension polymerization, emulsion polymerization, seed polymerization and dispersion polymerization) of monomers.

(b) When the resin is a polyaddition resin or a polycondensation resin such as a polyester resin, a polyurethane resin and an epoxy resin, aqueous dispersoids of the fine resin particles are manufactured by dispersing a precursor (e.g., monomer and oligomer) or a solvent solution thereof in an aqueous medium with a suitable dispersant and curing the mixture with heat or a curing agent.

(c) When the resin is a polyaddition resin or a polycondensation resin such as a polyester resin, a polyurethane resin and an epoxy resin, a precursor (e.g., monomer and oligomer) or a solvent solution thereof (preferably liquid or may be liquefied by heat) is subjected to phase-inversion emulsification by adding water after a suitable emulsifying agent is added thereto.

(d) A resin prepared by polymerization reaction (e.g., addition polymerization, ring-opening polymerization, polyaddition, addition condensation and condensation polymerization) is pulverized using a mechanical rotational pulverizer or a jet pulverizer and classified. The obtained resin particulates are dispersed in water with a suitable dispersant.

(e) A resin prepared by polymerization reaction (e.g., addition polymerization, ring-opening polymerization, polyaddition, addition condensation and condensation polymerization) is dissolved in a solvent. The resin solution is sprayed in mist, and the obtained fine resin particles are dispersed in water with a suitable dispersant.

(f) A resin prepared by polymerization reaction (such as addition polymerization, ring-opening polymerization, polyaddition, addition condensation and condensation polymerization) is dissolved in a solvent to prepare a resin solution and another solvent is added to the resin solution. Alternatively, the resin is heated to be dissolved in the solvent, and the obtained resin solution is cooled down to precipitate fine resin particles. The solvent is then removed to obtain the fine resin particles and dispersed in water with a suitable dispersant.

(g) A resin prepared by polymerization reaction (e.g., addition polymerization, ring-opening polymerization, polyaddition, addition condensation and condensation polymerization) is dissolved in a solvent, and the obtained resin solution is dispersed in an aqueous medium with a suitable dispersant. The solvent is removed by heat or decompression.

(h) A resin prepared by polymerization reaction (e.g., addition polymerization, ring-opening polymerization, polyaddition, addition condensation and condensation polymerization) is dissolved in a solvent. The obtained resin solution is subjected to phase-inversion emulsification by adding water after a suitable emulsifying agent is added to the resin solution.

(Surfactant)

A surfactant or the like may be optionally used to emulsify or disperse an oil phase containing toner ingredients.

Examples of the surfactants include anionic surfactants (e.g., alkylbenzene sulfonic acid salts, α-olefin sulfonic acid salts and phosphates); cationic surfactants such as amine salts (e.g., alkyl amine salts, aminoalcohol fatty acid derivatives, polyamine fatty acid derivatives and imidazoline) and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants (e.g., fatty acid amide derivatives and polyhydric alcohol derivatives); and ampholytic surfactants (e.g., alanine, dodecyldi(aminoethyl)glycin, di(octylaminoethyl)glycin and N-alkyl-N,N-dimethylammonium betaine).

Moreover, an extremely small amount of a surfactant containing a fluoroalkyl group enables emulsification and dispersion. Examples of a preferred anionic surfactant containing a fluoroalkyl group include fluoroalkyl carboxylic acids having 2 to 10 carbon atoms and metal salts thereof, disodium perfluorooctanesulfonylglutamate, sodium 3-[ω-fluoroalkyl(C6-C11)oxy]-1-alkyl(C₃-C₄) sulfonate, sodium 3-[ω-fluoroalkanoyl (C6-C8)-N-ethylamino]-1-propanesulfonate, fluoroalkyl (C11-C20) carboxylic acids and metal salts thereof, perfluoroalkyl (C7-C13) carboxylic acids and metal salts thereof, perfluoroalkyl (C4-C12) sulfonate and metal salts thereof, perfluorooctanesulfonic acid diethanol amides, N-propyl-N-(2-hydroxyethyl)perfluorooctanesulfone amide, perfluoroalkyl (C6-C10)sulfoneamidepropyltrimethyl ammonium salts and salts of perfluoroalkyl (C6-C10)-N-ethylsulfonyl glycin and monoperfluoroaklyl (C6-C16)ethylphosphates. Examples of the cationic surfactants containing a fluoroalkyl group include primary, secondary, and tertiary aliphatic amines containing a fluoroalkyl group, aliphatic quaternary salts such as perfluoroalkyl (C₆-C₁₀)sulfoneamidepropyltrimethyl ammonium salts, benzalkonium salts, benzetonium chloride, pyridinium salts and imidazolinium salt.

(Protective Colloid)

Further, it is possible to stabilize the dispersed liquid droplets by using a polymeric protective colloid. Examples of the protective colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride); (metha)acrylic monomers containing a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide); vinyl alcohols and ethers thereof (e.g., vinyl methyl ether, vinyl ethyl ether and vinyl propyl ether); esters of vinyl alcohols with a compound containing a carboxyl group (e.g., vinyl acetate, vinyl propionate and vinyl butyrate); acrylic amides (e.g., acrylamide, methacrylamide and diacetoneacrylamide) and methylol compounds thereof; acid chlorides (e.g., acrylic acid chloride and methacrylic acid chloride); homopolymers and copolymers which contains a nitrogen atom or an alicyclic ring containing a nitrogen atom (e.g. vinyl pyridine, vinyl pyrrolidone, vinyl imidazole and ethylene imine); polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters and polyoxyethylene nonylphenyl esters); and cellulose compounds (e.g., methyl cellulose, hydroxyethyl cellulose and hydroxypropyl cellulose)

When compounds soluble to acids and alkali (e.g., calcium phosphate) are used as a dispersion stabilizer, calcium phosphate is removed from the fine particles by washing the fine particles with water after calcium phosphate is dissolved by an acid such as hydrochloric acid. An enzyme may decompose the calcium phosphate to remove. When the dispersant is used, the dispersant may remain on the surface of the toner particles. However, it is preferable to remove the dispersant by washing in terms of the chargeability of the toner.

(Dispersion)

For the dispersion, any known machines (e.g., a low shearing machine, a high shearing machine, a frictional machine, a high-pressure jet machine and a ultrasonic machines) can be used. To prepare dispersoids with a diameter ranging from 2 μm to 20 μm, a high shearing machine is preferably used. When a high shearing disperser machine is used, revolutions per minute (rpm) is not particularly limited, but is normally 1,000 rpm to 30,000 rpm and preferably 5,000 rpm to 20,000 rpm. The temperature in the dispersion is normally 0° C. to 150° C. (under pressure) and preferably 20° C. to 80° C.

(Controlling Diameter and Shape of Toner in Dispersion)

Per unit energy and time of dispersion mainly control the diameter of the toner oil droplets. Dispersed fine particles may collide with each other to adhere and aggregate. This increases the thixotropy of the oil phase with the layered compounds (i.e., modified inorganic layered mineral), and the adhered and aggregated fine particles cannot integrally form one approximately spherical shape, thereby forming a distorted shape. However, a resin, which has a polyester skeleton with an acid value of 15 KOHmg/g or less, is used as a first resin according to the present invention to prevent the aggregation. Therefore, the toner can be approximately spherical.

(Desolvation)

In order to remove the organic solvent from the obtained emulsified dispersoids, any known removing methods can be used. For example, a whole system is gradually heated under normal pressure or reduced pressure to completely evaporate the organic solvent in the droplets.

(Elongation and/or Crosslinking)

To introduce a modified polyester resin containing a urethane and/or urea group, the modified polyester resin having an isocyanate group at an end is mixed with amines capable of reacting therewith. The amines may be mixed in the oil phase or added in an aqueous medium before the toner ingredients are dispersed in the aqueous medium. Reaction time depends on a structure of the isocyanate group contained in the polyester prepolymer and reactivity thereof with the amines. However, the reaction time is normally 1 minute to 40 hours, and preferably 1 hour to 24 hours. The reaction temperature is normally 0° C. to 150° C. and preferably 20° C. to 98° C. The reaction can be performed after the fine particles are added. In addition, known catalysts can be optionally used.

<Washing and Drying>

The toner particles dispersed in an aqueous medium are washed and dried by any known methods.

Specifically, solid-liquid separation is performed by a centrifuge or a filter press. The obtained toner cake is dispersed in ion exchanged water at a temperature of room temperature to 40° C. pH is adjusted by acid and base as necessary. The solid-liquid separation is performed again. Impurities and the surfactant are removed by repeating this process several times. Toner powder is finally obtained by drying the tone cake with a flash dryer, a circulating dryer, a vacuum dryer, a vibrating fluid dryer or the like. Unnecessary fine particles of the toner may be removed by a centrifuge. In addition, the toner particles can have a desired particle size distribution by using a known classifier as necessary after the toner cake is dried.

### <External Additive Treatment>

The obtained dry toner powder is mixed with the fine charge control particles and/or the fine plasticizer particles or mechanical impact is applied to the mixed powder so that the mixed powder is fixed. This prevents the different particles to come off from the surface of the obtained complex particles. More specifically, an impact is applied to the mixture by a blade which rotates at high speed. Alternatively, the mixture is entered to a high-speed flow to accelerate so that particles collide with each other or complex particles collide with an appropriate impinging plate. Examples of this mechanical impact applicators include ONG MILL (manufactured by Hosokawa Micron Co., Ltd.), a modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTON SYSTEM (manufactured by Kawasaki Heavy Industries, Ltd.) and a automatic mortar.

The toner according to the present invention is preferably a negatively-charged nonmagnetic one-component toner.

This negatively-charged nonmagnetic one-component toner is suitably used in a cleanerless image forming apparatus to achieve the aforementioned properties.

Moreover, the latent electrostatic image developing toner according to the present invention may be used as the one-component developer or two-component developer composed of the latent electrostatic image developing toner and a latent electrostatic image developing carrier. Both developers can be suitably used for the cleanerless image forming apparatus. The toner has excellent durability, and the chargeability of the toner is maintained in long-term printing. Thus, the toner is able to form a stable high-quality image.

Note that latent electrostatic image developing carrier (carrier) used in the electrophotographic developer of the present invention is not particularly limited. For example, a carrier having a coating layer, which contains a binder resin and fine conductive particles, on the core thereof may be used.

Known electrophotographic two-component carrier materials may be used as the carrier core material. For example, ferrite, Cu—Zn ferrite, Mn Ferrite, Mn—Mg ferrite, Mn—Mg—Sr ferrite, magnetite, iron and nickel may be selected and used as needed for the carrier.

Furthermore, the latent electrostatic image developing toner of the present invention may be stored in a container to be used. According to the toner container storing the toner, the toner is stably maintained under environmental changes and simply and easily handled. Moreover, the apparatus is kept clean.

### <Image Forming Apparatus>

A compact cleanerless image forming apparatus according to the present invention takes up less space and is provided with a photoconductor, a charging unit, an exposing unit, a developing unit, a transferring unit and a fixing unit. The developing unit stores the latent electrostatic image developing toner of the present invention

The latent electrostatic image developing toner of the present invention is constituted by approximately spherical fine particles with the average circularity of 0.970 or more. The particles are prepared by dispersing and/or emulsifying an oil phase in an aqueous medium. Thus, less toner waste is generated in the cleanerless image forming apparatus. The toner achieves excellent chargeability, durability, low-temperature fixability and thermal resistance and storage stability with high circularity. Therefore, the toner is able to form a stable image for an extended period of time and suitably used in an oilless fixing system.

A roller provided with a heating device is preferably used as a fixing member of the fixing unit. The roller fixing unit provided with a heating device uniformly, stably and continuously fixes a developing image of the latent electrostatic image developing toner without causing toner offset or the like. In addition, oil application to the fixing member of the fixing unit is preferably unnecessary. This simplifies the apparatus and reduces the size and manufacturing costs thereof.

The cleanerless image forming apparatus is detailed below.

### <Cleanerless Image Forming Apparatus>

The following process cartridge, for example, is used in the cleanerless image forming apparatus according to the present invention. As shown in FIG. 4, the apparatus is provided with a latent electrostatic image bearing member 22, a latent electrostatic image bearing member charging unit (latent electrostatic image bearing member charging member) 26, a charging member 24 and a developing unit (developing device) 27. Herein, the charging member 24 recharges the residual toner on the latent electrostatic image bearing member after the transfer.

Herein, the operation of the apparatus is described. The latent electrostatic image bearing member is rotated at a predetermined circumferential speed. As the latent electrostatic image bearing member rotates, the charging unit uniformly charges the peripheral surfaces of the members with predetermined positive or negative electric potential. The latent electrostatic image bearing members receives image exposure light from an image exposing unit (e.g., slit exposure and laser beam scanning exposure), and latent electrostatic images are sequentially formed on the peripheral surfaces of the latent electrostatic image bearing members. The developing unit develops the latent electrostatic images with a toner, and the transferring unit sequentially transfers the toner images onto a transferring member 23, which is sent in synchronization with the rotation of the latent electrostatic image bearing member from a paper feeding portion to a portion between the latent electrostatic image bearing member and the transferring unit (transfer supporting member) 28. The transferring member received the images is detached from the surface of the latent electrostatic image bearing member and sent to an image fixing unit (not shown) so that the images are fixed. Finally, a duplicate (copy) or a print is made and sent outside the apparatus.

The charging member 24 recharges the surface of the latent electrostatic image bearing member to recharge the residual toner thereon after the transfer. The recharged residual toner is then detached from the charged portion of the latent electrostatic image bearing member, collected in the developing step and used in the next image formation. Note that a reference numeral 25 denotes a sheet pressure contacting member (sponge).

The charging member, which recharges the residual toner on the latent electrostatic image bearing member after the transfer, is preferably conductive because the toner adheres to the charging member due to a charge up if the charging member is an insulator.

The surface resistance and the volume resistance are preferably 10² to 10⁸ Ω/sq and 10¹ to 10⁶ Ω·cm, respectively. Examples of the shape of the charging member are a roller, a brush and a sheet. To recharge the residual toner, the sheet is more preferable. The charging member is preferably a sheet made of NYLON, PTFE, PVDF or urethane. In consideration of the chargeability of the toner, PTFE and PVDF sheets are more preferable.

When the charging member is a conductive sheet, the thickness of the sheet preferably ranges from 0.05 mm to 0.5 mm due to the contact pressure with the latent electrostatic image bearing member. When the charging member is a conductive sheet, the width of a nip, which contacts the latent image carrier, preferably ranges from 1 mm to 10 mm in consideration of contacting time to charge toner. The electrical potential applied to the charging member preferably ranges from −1.4 kV to 0 kV to charge the toner.

### <Process Cartridge>

The process cartridge of the present invention is used in the abovementioned image forming apparatus. The process cartridge integrally incorporates a photoconductor and at least one unit selected from a charging unit charging the photoconductor, a developing unit and cleaning unit (including a collecting unit of a developing device except a blade cleaning unit). The process cartridge is detachable from the image forming apparatus. Specifically, in the present invention, the process cartridge integrally incorporates a plurality of constituents such as the abovementioned photoconductor, charging unit, developing unit and cleaning unit (including the collecting unit of the developing device except the blade cleaning unit). This process cartridge is detachable from the image forming apparatus such as a copier and a printer.

The latent electrostatic image developing toner (developer) of the present invention can be used in, for example, the image forming apparatus provided with a process cartridge as shown in FIG. 2.

FIG. 2 shows an example of the process cartridge utilizing the electrophotographic developer of the present invention.

As shown in FIG. 2, a process cartridge 6 of the present invention integrally incorporates a photoconductor 7 and at least one selected from a charging unit 8, a developing unit 9 and a cleaning unit 10. The process cartridge is detachable from the image forming apparatus. Herein, the cleaning unit 10 includes a collecting unit of the developing device except a blade cleaning unit.

The operation of the image forming apparatus with the process cartridge is described. The photoconductor is rotated at a predetermined circumferential speed. As the photoconductor rotates, the charging unit uniformly charges the peripheral surfaces of the photoconductor with predetermined positive or negative electric potential. The photoconductor receives image exposure light from an image exposing unit (e.g., slit exposure and laser beam scanning exposure), and latent electrostatic images are sequentially formed on the peripheral surfaces of the photoconductors. The developing unit develops the latent electrostatic images with a toner, and the transferring unit sequentially transfers the toner images onto a transferring member 23, which is sent in synchronization with the rotation of the photoconductor from a paper feeding portion to a portion between the photoconductor and the transferring unit. The transferring member received the images is detached from the surface of the photoconductor and sent to an image fixing unit so that the images are fixed. Finally, a duplicate (copy) or a print is made and sent outside the apparatus. The cleaning unit cleans the surface of the photoconductor by removing the residual toner after the transferring. The charge is eliminated from the photoconductor, and the photoconductor is used for the next image formation.

The toner was analyzed and evaluated as described below. Note that the one-component developer was evaluated herein. However, the toner of the present invention may be used as a two-component developer when suitable external additive treatment is performed and a suitable carrier is used.

### <Measurement Method>

### (Particle Diameter)

Next, the measurement method of particle diameter of the toner is described.

To measure the particle size distribution of the toner particle by Coulter Counter, COULTER COUNTER TA-II or COULETR MULTISIZER II (both are manufactured by Coulter Electrons Inc.) may be used. The measurement method is described below.

0.1 ml to 5 ml of a surfactant (preferably alkylbenzene sulfonate) serving as a dispersant is added to 100 ml to 150 ml of an electrolyte. Herein, the electrolyte is a 1% NaCl aqueous solution containing a first grade sodium chloride. For example, ISOTON-II (manufactured by Coulter Electrons Inc.) can be used. 2 mg to 20 mg in solid of a target sample is added to the electrolyte, and the electrolyte is dispersed using an ultrasonic disperser for about 1 minute to 3 minutes. The volume and the number of toner particles are measured by the above instrument with an aperture of 100 μm to determine the volume and number distribution. From the obtained distributions, the volume average particle diameter (Dv) and the number average particle diameter (Dn) are determined.

For example, the following 13 channels may be used: 2.00 μm to less than 2.52 μm; 2.52 μm to less than 3.17 μm; 3.17 μm to less than 4.00 μm; 4.00 μm to less than 5.04 μm; 5.04 μm to less than 6.35 μm; 6.35 μm to less than 8.00 μm; 8.00 μm to less than 10.08 μm; 10.08 μm to less than 12.70 μm; 12.70 μm to less than 16.00 μm; 16.00 μm to less than 20.20 μm; 20.20 μm to less than 25.40 μm; 25.40 μm to less than 32.00 μm; and 32.00 μm to less than 40.30 μm. Thus, it is possible to measure particles with a particle diameter of 2.00 μm to less than 40.30 μm.

(Glass Transition Point)

Glass transition points of the polyester resin and the vinyl copolymer resin can be measured by a differential scanning calorimeter (e.g., DSC-6220R manufactured by Seiko Instruments Inc.). First, the polyester resin or the vinyl copolymer resin is heated to 150° C. from room temperature with a temperature increase rate of 10° C./min. Second, the resin is left at 150° C. for 10 minutes. Third, the resins are cooled down to the room temperature and left for 10 minutes. Finally, the resin is again heated to 150° C. with a temperature increase rate of 10° C./min. The glass transition point is obtained from an intersection between a base line of a glass transition point or less and a tangent of a curve showing the glass transition.

(Diameter of Fine Particles)

The diameter of the fine vinyl copolymer resin particles or the like can be measured by LA-920 (manufactured by Horiba Ltd.), UPA-EX150 (manufactured by Nikkiso Co., Ltd.) or the like by subjecting the dispersoids to the measurement.

(Area Occupied by Modified Inorganic Layered Mineral)

An area, which is occupied by the modified inorganic layered mineral in a region 50 nm apart from the periphery of the toner, can be measured by using a FE-SEM.

A sample was prepared as follows: several tens percentage by mass of a toner was embedded in an epoxy resin; after being cured, the resin was cut by a microtome with a diamond knife to expose the cross-section of the resin; the obtained sample was fixed on a flat metal plate of the FE-SEM; and a backscattered electron image of the obtained sample was observed.

The measurement conditions were as follows:

Apparatus: ULTRA-55 (manufactured by Carl Zeiss Inc.)

Magnification: 1.3

Acceleration Voltage: 0.8 kV

Applied Current: 160 μA

The backscattered electron image of the obtained sample was incorporated into image analysis software (e.g., Photoshop C2 manufactured by Adobe Systems Inc.). In the binarized image, the inorganic layered mineral and the background were separated, and an area (A) of the inorganic layered mineral was obtained. Moreover, an area (B) of a region 50 nm apart from the periphery of the toner was obtained. From the expression below, the area occupied by the inorganic layered mineral in the region was calculated.

A/B×100(%)

### <Evaluation>

### (Adhesion Evaluation of Developer Regulation Blade)

The toner (developer) subjected to external additive treatment was stored in a black toner cartridge for LP-1500C (manufactured by Epson Corp.). Toner adhesion to the developer regulation blade was visually observed after first 50 sheets and 800 sheets were printed out. Evaluation criteria are as follows:

A No adhesion

B Slight adhesion was observed, but it did not affect the quality of a printed sheet

C Adhesion was significant.

### (Background Smear Evaluation)

The toner (developer) subjected to external additive treatment was stored in a black toner cartridge for LP-1500C (manufactured by Epson Corp.). A piece of colorless transparent tape was adhered to an uncleaned portion of the photoconductor to take off the residual toner thereon after first 50 sheets and 800 sheets were printed out. The tape was then adhered to a white sheet, and L* was measured by spectrodensitometer, X rite 939. Evaluation criteria are as follows:

A 90 or more

B 80 to 89

C 80 or less.

### EXAMPLES

The present invention is further detailed hereinafter with reference to Examples 1 to 4 and Comparative Examples 1 and 2. However, the present invention is not limited to these Examples. Note that “parts” means parts by mass in these Examples.

Polyester resins (polyester P-1 to P-3) and prepolymers used for the preparation of toners in the Examples 1 to 4 and Comparative Examples 1 and 2 were synthesized as described below.

### <Polyester Synthesis 1>

### [Polyester (P-1)]

The following components were fed to a reaction vessel equipped with a condenser tube, a stirrer and a nitrogen inlet pipe: ethylene oxide (2 mol) adduct of bisphenol A 239 parts; propylene oxide (3 mol) adduct of bisphenol A 553 parts; terephthalic acid 180 parts; adipic acid 40 parts; and dibutyltin oxide 2 parts. The mixture was reacted for 8 hours at 230° C. under normal pressure. The reaction was continued for 5 more hours under reduced pressure of 10 to 15 mmHg. 1 part of trimellitic anhydride was added to the reaction vessel, and the reaction was further continued for 2 hours at 180° C. under normal pressure. Finally, polyester (P-1) was obtained. The polyester (P-1) had a number average molecular weight of 2,500, a weight average molecular weight of 6,500, a glass transition temperature (Tg) of 47° C. and an acid value of 2.5.

### [Polyester (P-2)]

The following components were fed to a reaction vessel equipped with a condenser tube, a stirrer and a nitrogen inlet pipe: ethylene oxide (2 mol) adduct of bisphenol A 210 parts; propylene oxide (3 mol) adduct of bisphenol A 581 parts; terephthalic acid 238 parts; adipic acid 58 parts; and dibutyltin oxide 2 parts. The mixture was reacted for 8 hours at 230° C. under normal pressure. The reaction was continued for 5 more hours under reduced pressure of 10 to 15 mmHg. 11 parts of trimellitic anhydride was added to the reaction vessel, and the reaction was further continued for 2 hours at 180° C. under normal pressure. Finally, polyester (P-2) was obtained. The polyester (P-2) had a weight average molecular weight of 5,300, a glass transition temperature (Tg) of 48° C. and an acid value of 12.2.

### [Polyester (P-3)]

The following components were fed to a reaction vessel equipped with a condenser tube, a stirrer and a nitrogen inlet pipe: ethylene oxide (2 mol) adduct of bisphenol A 553 parts; propylene oxide (2 mol) adduct of bisphenol A 196 parts; terephthalic acid 220 parts; adipic acid 45 parts; and dibutyltin oxide 2 parts. The mixture was reacted for 8 hours at 230° C. under normal pressure. The reaction was continued for 5 more hours under reduced pressure of 10 to 15 mmHg. 26 parts of trimellitic anhydride was added to the reaction vessel, and the reaction was further continued for 2 hours at 180° C. under normal pressure. Finally, polyester (P-3) was obtained. The polyester (P-3) had a number average molecular weight of 2,200, a weight average molecular weight of 5,600, a glass transition temperature (Tg) of 43° C. and an acid value of 24.

### <Prepolymer Synthesis 1>

The following components were fed to a reaction vessel equipped with a condenser tube, a stirrer and a nitrogen inlet pipe: 1,2-propylene glycol 366 parts; terephthalic acid 566 parts; trimellitic anhydride 44 parts; and titanium tetrabutoxyde 6 parts. The mixture was reacted for 8 hours at 230° C. under normal pressure. The reaction was continued for 5 more hours under reduced pressure of 10 to 15 mmHg. Intermediate polyester (1) was then obtained. The intermediate polyester (1) had a number average molecular weight of 3,200, a weight average molecular weight of 12,000 and a glass transition temperature (Tg) of 55° C.

Next, the following components were fed in a reaction vessel equipped with a condenser tube, a stirrer and a nitrogen inlet pipe: intermediate polyester (1) 420 parts; isophorone diisocyanate 80 parts; and ethyl acetate 500 parts. The mixture was reacted for 5 hours at 100° C., and prepolymer 1 (PP-1) was obtained. The prepolymer 1 (PP-1) had 1.34% by mass of free isocyante group.

### <Masterbatch Synthesis 1>

The following components were mixed using HENSCHEL MIXER: carbon black (REGAL 400R manufactured by Cabot Corp.) 40 parts; polyester resin (RS-801 manufactured by Sanyo Chemical Industries Ltd, having an acid value of 10, Mw of 20,000 and Tg of 64° C.) 60 parts; and water 30 parts. Thus, a mixture was obtained, in which pigment aggregation was impregnated with water.

The mixture was kneaded with a two-roll mill, in which the surface temperature of the rolls was 130° C., for 45 minutes and pulverized into particles having a diameter of 1 mm using a pulverizer. Thus, a masterbatch (1) was obtained.

The molecular weight was measured by the aforementioned method, and Tg was measured by the following method.

The glass transition points of the polyester resin and the vinyl copolymer resin can be measured by a differential scanning calorimeter (e.g., DSC-6220 manufactured by Seiko Instruments Inc.) First, the polyester resin and the vinyl copolymer resin were heated to 150° C. from room temperature with a temperature increase rate of 10° C./min. Second, the resins were left at 150° C. for 10 minutes. Third, the resins were cooled down to the room temperature and left for 10 minutes. Finally, the resins were again heated to 150° C. with a temperature increase rate of 10° C./min. The glass transition point is obtained from a midpoint of the transitional curve between two baselines. One baseline indicates a glass transition point or less, the other baseline indicates a glass transition point or more.

### Example 1

### Preparation of Dispersion Liquid (Oil Phase)

The following components were fed to a container equipped with a thermometer and a stirrer: polyester (1) 96 parts: paraffin wax (melting point of 72° C.) 32 parts; montmorillonite (CLAYTON APA manufactured by Southern Clay Inc., an inorganic layered mineral in which some interlayer ions were modified by a quaternary ammonium salt having a benzyl group) 8 parts; and ethyl acetate 383 parts. The mixture was stirred, heated to 80° C. and retained at 80° C. for 5 hours. The mixture was cooled down to 30° C. in one hour. The mixture was transferred to a different container and dispersed by a bead mil (ULTRA VISCO MILL manufactured by Aimex Co., Ltd.) under “3 pass” conditions of a liquid transfer rate of 1 kg/hr, a disk circumferential speed of 6 m/second and a loading of 0.5 mm zirconia beads of 80% by volume. Thus, an ingredient solution (1) was obtained. 338 parts of a 70% solution of polyester (1) in ethyl acetate and 140 parts of masterbatch (1) were added to 325 parts of the ingredient solution (1). The obtained mixture was stirred by THREE ONE MOTOR for 2 hours. Thus, an oil phase (1) was obtained. Ethyl acetate was added to the oil phase (1) so that the solid content (measured in 30 minutes at 130° C.) of the oil phase (1) becomes 50%.

### <Preparation of Aqueous Phase>

834.5 parts of ion exchanged water, 154 parts of a 50% aqueous solution of a sodium dodecyldiphenyl ether disulfonate (ELEMINOL MON-7 manufactured by Sanyo Chemical Industries Ltd.), 192.5 parts of a 1% aqueous solution of carboxymethyl cellulose serving as a viscosity controlling agent, and 102 parts of ethyl acetate were mixed and stirred. Thus, a milky white liquid, an aqueous phase (1), was obtained.

### <Emulsification>

115 parts of the prepolymer (1) and 1.5 parts of isophoronediamine were added to the total amount of the oil phase (1) and mixed for 1 minute by TK HOMOMIXER (manufactured by Tokushu Kika Kogyo K.K.) at 5,000 rpm. 835 parts of an aqueous phase (1) was added thereto and mixed for 5 minutes by TK HOMOMIXER at 8,000 to 13,000 rpm. Thus, an emulsified slurry (1) was obtained.

### <Desolvation>

The emulsified slurry (1) was fed into a container equipped with a stirrer and a thermometer and subjected to desolvation for 8 hours at 30° C. Thus, a dispersion slurry (1) was obtained.

### <Washing and Drying>

1,000 parts of the dispersion slurry (1) was filtered under reduced pressure.

(1) The obtained filter cake was mixed with 1,000 parts of ion exchanged water for 10 minutes by TK HOMOMIXER at 12,000 rpm, and then filtered.

(2) The filter cake obtained in the process (1) was mixed with 1,000 parts of ion exchanged water for 30 minutes by TK HOMOMIXER at 12,000 rpm under application of an ultrasonic wave. The filter cake (1) was filtered under reduced pressure. This process was repeated until the electric conductivity of a reslurry liquid became 10 μC/cm or less.

(3) The reslurry liquid of the process (2) was mixed with a 10% aqueous solution of hydrochloric acid so that the reslurry liquid had a pH of 4. The reslurry liquid was agitated for 30 minutes by THREE ONE MOTOR and filtered.

(4) The filter cake of the process (3) was mixed with 1,000 parts of ion exchanged water for 10 minutes by TK HOMOMIXER at 12,000 rpm and filtered. This process was repeated until the electric conductivity of the reslurry liquid became 10 μC/cm or less. Finally, a filter cake (1) was obtained.

The filter cake (1) was dried for 48 hours at 45° C. by a circulating air drier and sieved with a screen having openings of 75 μm. Thus, a toner base (1) was obtained. The toner base (1) had a volume average particle diameter (Dv) of 5.3 μm, a number average particle diameter (Dn) of 4.8 μm, a ratio (Dv/Dn) of 1.10 and an average circularity of 0.975.

Next, 100 parts of the toner base (1) was mixed with 0.5 parts of hydrophobic silica having a primary particle diameter of approximately 30 nm and 0.5 parts of hydrophobic silica having a primary particle diameter of approximately 10 nm by HENSCHEL MIXER. Thus, a developer (1), the latent electrostatic image developing toner of the present invention (a negatively-charged nonmagnetic one-component developing toner), was obtained.

Table 1 shows amounts of the first resin and second resin contained in the developer (1), the acid value of the first resin, the volume average particle diameter (Dv) and number average particle diameter (Dn) of the toner, the ratio thereof (Dv/Dn) and the average circularity.

### Example 2

The latent electrostatic image developing toner (developer (2)) of the present invention was obtained in the same manner as in Example 1 except that the first binder resin P-2 was used instead of P-1 and the proportion of the first resin P-2 and the second resin PP-1 was changed. Table 1 shows the proportion (% by mass) of the first resin and the second resin, the acid value of the first resin, the volume average particle diameter (Dv) and number average particle diameter (Dn) of the toner, the ratio thereof (Dv/Dn) and the average circularity in the obtained developer (2).

### Example 3

The latent electrostatic image developing toner (developer (3)) of the present invention was obtained in the same manner as in Example 1 except that the proportion of the first resin and the second resin was changed. Table 1 shows the proportion (% by mass) of the first resin and the second resin, the acid value of the first resin, the volume average particle diameter (Dv) and number average particle diameter (Dn) of the toner, the ratio thereof (Dv/Dn) and the average circularity in the obtained developer (3).

### Example 4

The latent electrostatic image developing toner (developer (4)) of the present invention was obtained in the same manner as in Example 1 except that the first binder resin P-2 was used instead of P-1 and the proportion of the first resin P-2 and the second resin PP-1 was changed. Table 1 shows the proportion (% by mass) of the first resin and the second resin, the acid value of the first resin, the volume average particle diameter (Dv) and number average particle diameter (Dn) of the toner, the ratio thereof (Dv/Dn) and the average circularity in the obtained developer (4).

### Comparative Example 1

The comparative latent electrostatic image developing toner (developer (5)) was obtained in the same manner as in Example 1 except that the first binder resin P-3 was used instead of P-1 and the proportion of the first resin and the second resin was changed. Table 1 shows the proportion (% by mass) of the first resin and the second resin, the acid value of the first resin, the volume average particle diameter (Dv) and number average particle diameter (Dn) of the toner, the ratio thereof (Dv/Dn) and the average circularity in the obtained developer (5).

### Comparative Example 2

The comparative latent electrostatic image developing toner (developer (5)) was obtained in the same manner as in Example 1 except that the mixing was performed in the emulsification for 10 minutes by TK HOMOMIXER at 8,000 rpm to 13,000 rpm. Table 1 shows the proportion (% by mass) of the first resin and the second resin, the acid value of the first resin, the volume average particle diameter (Dv) and number average particle diameter (Dn) of the toner, the ratio thereof (Dv/Dn) and the average circularity in the obtained developer (6).

The average circularity in Examples and Comparative Examples was measured using the aforementioned method.

The volume average particle diameter (Dv), the number average particle diameter (Dn) and the ratio thereof (Dv/Dn) were measured as described hereinafter. The measurement of the particle size distribution of the toner particle is described.

(Particle Diameter)

To measure the particle size distribution of the toner particle by Coulter Counter, COULTER COUNTER TA-II or COULETR MULTISIZER II (both are manufactured by Coulter Electrons Inc.) may be used. The measurement method is described below.

0.1 ml to 5 ml of a surfactant (preferably alkylbenzene sulfonate) serving as a dispersant was added to 100 ml to 150 ml of an electrolyte. Herein, the electrolyte is a 1% NaCl aqueous solution containing a primary sodium chloride. For example, ISOTON-II (manufactured by Coulter Electrons Inc.) may be used. 2 mg to 20 mg in solid of a target sample was added to the electrolyte, and the electrolyte was dispersed using an ultrasonic dispersing machine for about 1 minute to 3 minutes. The volume and the number of toner particles were measured by the above instrument using an aperture of 100 μm to determine volume and number distribution thereof. From the obtained distributions, the volume average particle diameter (Dv) and the weight average particle diameter (Dn) were determined.

For example, the following 13 channels may be used: 2.00 μm to less than 2.52 μm; 2.52 μm to less than 3.17 μm; 3.17 μm to less than 4.00 μm; 4.00 μm to less than 5.04 μm; 5.04 μm to less than 6.35 μm; 6.35 μm to less than 8.00 μm; 8.00 μm to less than 10.08 μm; 10.08 μm to less than 12.70 μm; 12.70 μm to less than 16.00 μm; 16.00 μm to less than 20.20 μm; 20.20 μm to less than 25.40 μm; 25.40 μm to less than 32.00 μm; and 32.00 μm to less than 40.30 μm. Thus, it is possible to measure particles with a particle diameter of 2.00 μm to less than 40.30 μm.

(Diameter of Fine Particles)

The diameter of the fine vinyl copolymer resin particles or the like can be measured with LA-920 (manufactured by Horiba Ltd.), UPA-EX150 (manufactured by Nikkiso Co., Ltd.) or the like by subjecting the dispersoids to the measurement.

The developers prepared in Examples 1 to 4 and Comparative Examples 1 and 2 were evaluated in terms of chargeability, stress resistance, transfer rate, separatability and thermal resistance and storage stability. The results of the evaluation are shown in Table 1.

### <Evaluation>

### (Evaluation of Chargeability)

IPSIO CX2500 (manufactured by Ricoh Co. Ltd.) employed the toner (developer), which had been subjected to external additive treatment, to continuously print a predetermined print pattern with a B/W ratio of 6% under an N/N environment (23° C., 45%). After the 50 sheets were printed under the N/N environment, the residual toner on a developing roller, which printed a pattern on a white sheet, was suctioned. The charge amount of the suctioned toner was measured by an electrometer to evaluate the charge amount. Evaluation criteria are as follows:

A: Charge amount is 30 μC/g or more

B: Charge amount is 25 μC/g or more and less than 30 μC/g

C: Charge amount is 20 μC/g or more and less than 25 μC/g

D: Charge amount is less than 20 μC/g

(Evaluation of Stress Resistance)

IPSIO CX2500 (manufactured by Ricoh Co. Ltd.) employed the toner (developer), which had been subjected to external additive treatment, to continuously print a predetermined print pattern with a B/W ratio of 6% under an N/N environment (23° C., 45%). After 2,000 sheets were continuously printed under the N/N environment, the residual toner on a developing roller, which printed a pattern on a white sheet, was suctioned. The electrical charge of the suctioned toner was measured by an electrometer to evaluate the charge amount differences after 50 and 2,000 sheets were printed. Evaluation criteria are as follows:

A: The absolute value of the charge amount difference is less than 5 μC/g

B: The absolute value of the charge amount difference is 5 μC/g or more and less than 10 μC/g

C: The absolute value of the charge amount difference is 10 μC/g or more and less than 15 μC/g

D: The absolute value of the charge amount difference is 15 μC/g or more

(Evaluation of Transfer Rate)

IPSIO CX2500 (manufactured by Ricoh Co. Ltd.) employed the toner (developer), which had been subjected to external additive treatment, to print a 1 cm-wide lateral black band. IPSIO CX2500 was put in forced outage while the lateral black band was developed on the photoconductor. An amount of toner adhesion to the photoconductor was measured. IPSIO CX2500 was put in operation again to print the band and forced outage while the band was transferred to the transferring member from the photoconductor. An amount of the toner adhesion to the transferring member was measured. Subsequently, an amount of the toner adhesions was obtained. Evaluation criteria are as follows:

A: An amount was approximately 100%

B: An amount was 98% or more and approximately 100% or less

C: An amount was 95% or more and less than 98%

D: An amount was 95% or less

(Evaluation of Separatability)

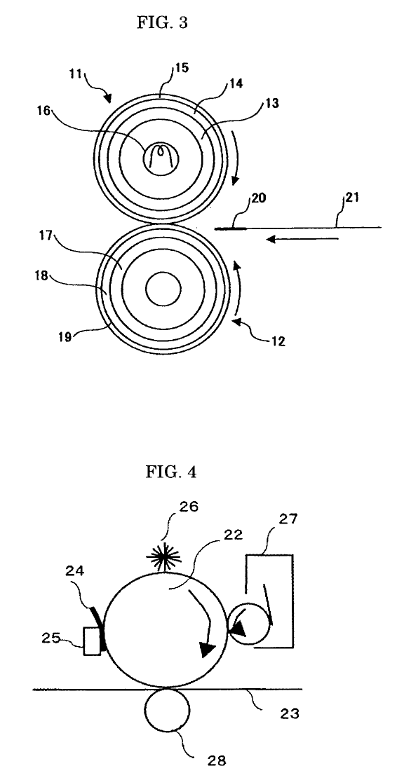

The toner (developer), which had been subjected to external additive treatment, was set in IPSIO CX2500 (from Ricoh Co., Ltd.). Unfixed 36 mm-wide solid images (toner adhesion: 11 g/m 2) were formed on the A4-size sheet at a position of 3 mm apart from the tip thereof while the A4-size sheet was fed in the vertical direction. The unfixed images were fixed using a fixing device shown in FIG. 3 at temperatures ranging from 115° C. to 175° C. in 10° C. steps to determine a temperature range in which a sheet was separable without causing toner offset. In this temperature range, a sheet was favorably separated from the heat roller, and toner offset did not occur. The sheet used for the evaluation had a basic weight of 45 g/m², which is disadvantageous for the separation, and a cross direction. The feeding speed of the fixing device was 120 mm/sec.

The fixing device shown in FIG. 3 includes a soft roller having a fluorinated outermost layer. Specifically, a heat roller 11 has an external diameter of 40 mm, an aluminum cored bar 13, an elastic layer 14 and an outermost layer 15. The elastic layer 14 is 1.5-mm thick, composed of silicone rubber and located on the aluminum cored bar 13. The outermost layer 15 is composed of tetrafluoroethylene-perfluoro alkylvinyl ether copolymer (PFA) and located on the elastic layer 14. The heat roller is further provided with a heater 16 inside the aluminum cored bar 13. A pressure roller 12 has an external diameter of 40 mm, an aluminum cored bar 17, an elastic layer 18 and an outermost layer 19. The elastic layer 18 is 1.5 mm-thick, composed of silicone rubber and located on the aluminum cored bar 17. The outermost layer 19 is composed of PFA and is located on the elastic layer 18. Note that a sheet 21 bearing an unfixed image 20 is proceeded as shown in FIG. 3. Evaluation criteria are as follows:

A: The sheet was separatable without causing toner offset at a temperature ranging from 115° C. to 175° C., and the fixed image was not damaged.

B: The sheet was separatable without causing toner offset in a temperature ranging from 115° C. to 175° C., and an image fixed at a low temperature was easily come off or damaged by scratching or rubbing.

C: The sheet was separable without causing toner offset at 30° C. or more and 50° C. or less.

D: The sheet was separable without causing toner offset at 30° C. or less.

(Thermal Resistance and Storage Stability)

The toner was stored for 8 hours at 50° C. and sieved by a screen with 42 meshes. An index of the thermal resistance and storage stability was determined by the amount of toner remaining on a wire net. The thermal resistance and storage stability were evaluated by the following criteria:

A: 30% or more

B: 20% or more and less than 30%

C: 10% or more and less than 20%

D: 10% or less

TABLE 1

| | | | | | | | Toner Particle Diameter | | |
|---|---|---|---|---|---|---|---|---|---|
| | | | | | | | Volume | Number | |
| | | Composition of Binder resin | | | | | Average | Average | |
| | | First Resin | | | Second Resin | | Particle | Particle | |
| | | | Acid Value | Amount | | Amount | Diameter | Diameter | |
| Example | Developer | Type | (KOHmg/g) | (wt %) | Type | (wt %) | Dv (μm) | Dn (μm) | Dv/Dn |
| Ex. 1 | 1 | P-1 | 2.5 | 85 | PP-1 | 15 | 5.3 | 4.8 | 1.10 |
| Ex. 2 | 2 | P-2 | 12.2 | 75 | PP-1 | 25 | 5.4 | 4.9 | 1.10 |
| Ex. 3 | 3 | P-1 | 2.5 | 70 | PP-1 | 30 | 5.7 | 5.1 | 1.12 |
| Ex. 4 | 4 | P-2 | 12.2 | 65 | PP-1 | 35 | 5.2 | 4.6 | 1.13 |
| Com. Ex. 1 | 5 | P-3 | 24 | 85 | PP-1 | 15 | 5.4 | 4.9 | 1.10 |
| Com. Ex. 2 | 6 | P-1 | 2.5 | 85 | PP-1 | 15 | 5.5 | 4.9 | 1.12 |

| | | Results of Evaluation | | | | |
|---|---|---|---|---|---|---|
| | Toner | | | | | Thermal |
| | Shape | | | | | Resistance |
| | Average | | Stress | Transfer | | and Storage |
| Example | Circularity | Chargeability | Resistance | Rate | Separatability | Stability |
| Ex. 1 | 0.975 | A | A | A | A | B |
| Ex. 2 | 0.971 | B | A | B | A | A |
| Ex. 3 | 0.974 | B | A | A | B | A |
| Ex. 4 | 0.981 | A | B | A | B | A |
| Com. Ex. 1 | 0.955 | A | B | D | C | A |
| Com. Ex. 2 | 0.959 | B | B | C | B | B |

As shown in Table 1, the developers (latent electrostatic image developing toners) in Examples 1 to 4 of the present invention performed extremely well in all the evaluations. By contrast, in Comparative Example 1, the toner was distorted with the circularity of 0.955, and the transfer rate was extremely low. Similar to Comparative Example 1, the toner in Comparative Example 2 was distorted with the circularity of 0.959, and the transfer rate was extremely low since the extremely long dispersion time caused aggregation.

As described above, the latent electrostatic image developing toner of the present invention can be particularly used for a compact cleanerless image forming apparatus taking up less space, and the image forming method employing the image forming apparatus to reduce toner waste. The toner has excellent chargeability and durability and achieves low-temperature fixability and thermal resistance and storage stability. Thus, the image quality can be improved even in high-speed printing. Moreover, it is possible to provide a developer, a toner container, an image forming apparatus and a process cartridge, which employ the toner.

The present invention is further detailed hereinafter with Examples 5 to 10.

### <Polyester Synthesis 2>

### (Polyester 10)

The following components were fed to a reaction vessel equipped with a condenser tube, a stirrer and a nitrogen inlet pipe: ethylene oxide (2 mol) adduct of bisphenol A 553 parts; propylene oxide (2 mol) adduct of bisphenol A196 parts; terephthalic acid 220 parts; adipic acid 45 parts; and dibutyltin oxide 2 parts. The mixture was reacted for 8 hours at 230° C. under normal pressure. The reaction was continued for 5 more hours under reduced pressure of 10 to 15 mmHg. 46 parts of trimellitic anhydride was added to the reaction vessel, and the reaction was further continued for 2 hours at 180° C. under normal pressure. Finally, polyester (10) was obtained. The polyester (10) had a number average molecular weight of 2200, a weight average molecular weight of 5,600, a glass transition temperature (Tg) of 43° C. and an acid value of 13.

### <Prepolymer Synthesis 2>

The following components were fed to a reaction vessel equipped with a condenser tube, a stirrer and a nitrogen inlet pipe: ethylene oxide (2 mol) adduct of bisphenol A 682 parts; propylene oxide (2 mol) adduct of bisphenol A 81 parts; terephthalic acid 283 parts; trimellitic anhydride 22 parts; and dibutyltin oxide 2 parts. The mixture was reacted for 8 hours at 230° C. under normal pressure. The reaction was continued for 5 more hours under reduced pressure of 10 to 15 mmHg. Thus, intermediate polyester (10) was obtained. The intermediate polyester (10) had a number average molecular weight of 2,100, a weight average molecular weight of 9,500, a glass transition temperature (Tg) of 55° C., an acid value of 0.5 and a hydroxyl value of 49.

Next, the following components were fed in a reaction vessel equipped with a condenser tube, a stirrer and a nitrogen inlet pipe: intermediate polyester (10) 411 parts; isophorone diisocyanate 89 parts; and ethyl acetate 500 parts. The mixture was reacted for 5 hours at 100° C., and prepolymer (10) was obtained. The prepolymer (10) had 1.53% by mass of free isocyante group.

### <Masterbatch Synthesis 2>

The following components were mixed using HENSCHEL MIXER: carbon black (REGAL 400R manufactured by Cabot Corp.) 40 parts; polyester resin (RS-801 manufactured by Sanyo Chemical Industries Ltd, having an acid value of 10, Mw of 20,000 and Tg of 64° C.) 60 parts; and water 30 parts. Thus, a mixture was obtained, in which pigment aggregation was impregnated with water. The mixture was kneaded with two-roll mill, in which the surface temperature of the rolls was 130° C., for 45 minutes and pulverized into particles having a diameter of 1 mm by a pulverizer. Thus, a masterbatch (10) was obtained.

### Example 5

### Preparation of Pigment/Wax Dispersion Liquid (Oil Phase)

The following components were fed to a container equipped with a stirrer and a thermometer: polyester (10) 378 parts: paraffin wax (HNP9) 120 parts; releasing agent (WAX) dispersant (styrene-polyethylene polymer having Tg of 73° C. and a number average molecular weight of 7100) 96 parts (releasing agent amount of 80%); and ethyl acetate 1,450 parts. The mixture was stirred, heated to 80° C. and retained for 5 hours at 80° C. The mixture was cooled down to 30° C. in one hour. 500 parts of the masterbatch (10) and 500 parts of ethyl acetate was fed to the container and mixed for one hour. Thus, an ingredient solution (10) was obtained.

1,500 parts of the ingredient solution (10) was transferred to a different container, and carbon black and WAX were dispersed by a bead mil (ULTRA VISCO MILL manufactured by Aimex Co., Ltd.) under the “three pass” conditions of a liquid transfer rate of 1 kg/hr, a disk circumferential speed of 6 m/second and a loading of 0.5 mm zirconia beads of 80% by volume. 665 parts of a 65% solution of polyester (10) in ethyl acetate was added and dispersed by the bead mill under the above conditions with “one pass.” Finally, a pigment/wax dispersion liquid (10) was obtained. Ethyl acetate was added to the pigment/wax dispersion liquid (10) so that the solid content (measured in 30 minutes at 130° C.) of the pigment/wax dispersion liquid (10) becomes 50%.

### <Preparation of Aqueous Phase>

953 parts of ion exchanged water, 88 parts of 25% by mass of aqueous dispersion liquid of fine organic resin particles (a copolymer of styrenes, methacrylic acids, butyl acrylates and sodium salts of methacrylate ethylene oxide adducts sulfate ester) serving as dispersion stabilizer; 80 parts of a 48.5% aqueous solution of sodium dodecyldiphenyl ether disulfonate (ELEMINOL MON-7 manufactured by Sanyo Chemical Industries Ltd.) and 113 parts of ethyl acetate were stirred and mixed. Thus, a milky white liquid, an aqueous phase (10) was obtained.

### <Emulsification>

967 parts of the pigment/wax dispersion liquid (10), 2% by mass (in toner solid content) of CLAYTON APA (manufactured by Southern Clay Products. Inc) and 6 parts of isophoronediamine (amine) were mixed for 1 minute by TK HOMOMIXER (manufactured by Tokushu Kika Kogyo K.K.) at 5,000 rpm. 137 parts of the prepolymer (10) were added thereto and mixed for 1 minute by TK HOMOMIXER (manufactured by Tokushu Kika Kogyo K.K.) at 5,000 rpm. 1,200 parts of the aqueous phase (10) were added and mixed for 20 minutes by TK HOMOMIXER at 8,000 rpm to 13,000 rpm. Thus, an emulsified slurry (10) was obtained.

### <Desolvation>

The emulsified slurry (10) was fed into a container equipped with a stirrer and a thermometer and subjected to desolvation for 8 hours at 30° C. Thus, a dispersion slurry (10) was obtained.

### <Washing and Drying>

100 parts of the dispersion slurry (10) were filtered under reduced pressure.

(1) The obtained filter cake was mixed with 100 parts of ion exchanged water for 10 minutes by TK HOMOMIXER at 12,000 rpm, and then filtered.

(2) The filter cake of the process (1) was mixed with 900 parts of ion exchanged water for 30 minutes by TK HOMOMIXER at 12,000 rpm under application of an ultrasonic wave. The filter cake was filtered under reduced pressure. This process was repeated until the electric conductivity of a reslurry liquid became 10 μC/cm or less.

(3) The reslurry liquid of the process (2) was mixed with a 10% aqueous solution of hydrochloric acid so that the reslurry liquid had a pH of 4. The reslurry liquid was stirred for 30 minutes with THREE ONE MOTOR and filtered.

(4) The filter cake of the process (3) was mixed with 100 parts of ion exchanged water for 10 minutes by TK HOMOMIXER at 12,000 rpm and filtered. This process was repeated until the electric conductivity of a reslurry liquid became 10 μC/cm or less. Finally, a filter cake (10) was obtained.

The filter cake (10) was dried for 48 hours at 45° C. by a circulating air drier and sieved with a screen having openings of 75 μm. Thus, toner base (10) was obtained. The toner base (10) had a volume average particle diameter (Dv) of 5.8 μm, a number average particle diameter (Dn) of 5.2 μm, a ratio (Dv/Dn) of 1.12, an average circularity of 0.973 and an ATR value of 0.04. 100 parts of the toner base, 1.5 parts of hydrophobic silica H2000/4 (a particle diameter of 12 nm, manufactured by Clariant Inc.) and 0.5 parts of hydrophobic silica RX50 (having a particle diameter of 40 nm, a product of Nippon Aerosil Co., Ltd) were mixed by HENSCHEL MIXER. Finally, toner (10) of the present invention was obtained.

The evaluation results of the toner (10) are shown in Table 2.

### Examples 6 to 10

The toners in Examples 6 to 10 were prepared in the same manner as in Example 5 except that an amount of MON-7 in the preparation of aqueous phase, an amount of fine organic resin particle dispersion liquid and emulsification time were changed as shown in Table 2. The evaluation results of the toners are shown in Table 2.

TABLE 2

| Treatment | | | | | Area | | | | | |
|---|---|---|---|---|---|---|---|---|---|---|
| | | | | Inorganic | Occupied | | | | | |
| | | | | Layered | by | | Evaluation Results | | | |
| | | | | Mineral | Modified | | Background smear | | Adhesion to Blade | |
| | | Organic | | Content | Inorganic | | After | After | After | After |
| | | Resin | | (wt % to | Layered | | Printing | Printing | Printing | Printing |
| | Mon-7 | Particle | Emulsification | Toner Solid | Mineral | Average | 50 | 800 | 50 | 800 |
| | (Parts) | Dispersant | Time (Min) | Parts) | (%) | Circularity | Sheets | Sheets | Sheets | Sheets |
| Ex. 5 | 80 | 88 | 20 | 2 | 90 | 0.973 | 92.3 | 91.1 | B | B |
| Ex. 6 | 90 | 63 | 20 | 2 | 85 | 0.971 | 92.5 | 91.0 | B | B |
| Ex. 7 | 90 | 88 | 40 | 2 | 95 | 0.970 | 91.8 | 90.5 | B | B |
| Ex. 8 | 90 | 75 | 20 | 2 | 80 | 0.971 | 93.2 | 88.7 | B | C |
| Ex. 9 | 86 | 88 | 20 | 2 | 75 | 0.975 | 92.1 | 89.4 | B | B |
| Ex. 10 | 90 | 88 | 30 | 2 | 70 | 0.978 | 90.5 | 85.3 | B | C |

The toner of the present invention has excellent chargeability, environmental stability and stable durability and offers favorable prints without a background smear or adhesion. Therefore, the toner may be suitably used as a developer for an electrostatic image in electrophotography, electrostatic recording and electrostatic printing and the like.

What is claimed is:

1. A latent electrostatic image developing toner used for a cleanerless image forming method, comprising: two or more binder resins; a colorant; a releasing agent; and a layered compound,
wherein the toner is constituted by particles which are prepared by granulation in an aqueous medium, and average circularity of the particles is 0.970 or more,
a first binder resin of the binder resins is a polyester resin with an acid value of 15 KOHmg/g or less, and
the layered compound is a modified layered compound in which at least some interlayer ions are modified by organic ions.

2. The latent electrostatic image developing toner according to claim 1, wherein a weight ratio of the first binder resin is 50% or more to a total amount of the binder resins.

3. The latent electrostatic image developing toner according to claim 1, wherein the layered compound is a modified inorganic layered mineral in which at least some interlayer cations are modified by organic cations.

4. The latent electrostatic image developing toner according to claim 1, wherein the binder resins comprises a modified polyester resin having a urethane and/or urea group.

5. The latent electrostatic image developing toner according to claim 1, wherein the polyester resin contains a modified polyester resin component elongated and/or crosslinked by a reaction between an amine and a polyester resin having an isocyanate group at an end thereof.

6. The latent electrostatic image developing toner according to claim 1, wherein an amount of the layered compound contained in the particles ranges from 0.5% by mass to 2.0% by mass.

7. The latent electrostatic image developing toner according to claim 1, wherein the toner is constituted by particles prepared by granulation in a manufacturing method which comprises:
dissolving or dispersing the binder resins, the colorant, the releasing agent and the layered compound in an organic solvent;
and dispersing and granulating dissolved matter or dispersed matter in the aqueous medium.

8. The latent electrostatic image developing toner according to claim 1, wherein the toner is a negatively-charged nonmagnetic one-component developing toner.

9. The latent electrostatic image developing toner according to claim 1, wherein a volume average particle diameter of the toner ranges from 4 μm to 8 μm, and the layered compound occupies 70% of a region 50 nm apart from a periphery of the toner in a backscattered electron image of a cross-section of the toner taken by a thermal FE-SEM.

10. An image forming method comprising: forming a latent image; developing the latent image by a toner; transferring; and fixing,
wherein the image forming method excludes cleaning a residual toner on an image carrier by using a blade after the transferring,
the toner contains two or more binder resins, a colorant, a releasing agent and a layered compound,
the toner is constituted by particles prepared by granulation in an aqueous medium, and average circularity of the particles is 0.970 or more,
a first binder resin of the binder resins is a polyester resin with an acid value of 15 KOHmg/g or less, and
the layered compound is a modified layered compound in which at least some interlayer ions are modified by organic ions.

11. An image forming apparatus, comprising: a photoconductor; a charging unit; an exposing unit; a developing unit; a transferring unit; and a fixing unit,
wherein the developing unit stores a toner containing two or more binder resins, a colorant, a releasing agent and a layered compound,
the toner is constituted by particles prepared by granulation in an aqueous medium, and average circularity of the particles is 0.970 or more,
a first binder resin of the binder resins is a polyester resin with an acid value of 15 KOHmg/g or less, and
the layered compound is a modified layered compound in which at least some interlayer ions are modified by organic ions.

12. The image forming apparatus according to claim 11, wherein a fixing member of the fixing unit is a roller provided with a heating device.

13. The image forming apparatus according to claim 11, wherein it is unnecessary to apply oil to the fixing member of the fixing unit.
